(19) United States
(12) Patent Application Publication
(10) Pub. No.: US 2026/0289630 A1
(43) Pub. Date: Sep. 24, 2026

(54) SYSTEM

(71) Applicant: SoftBank Group Corp., Tokyo (JP)

(72) Inventor: Go SATO, Tokyo (JP)

(73) Assignee: SoftBank Group Corp., Tokyo (JP)

(21) Appl. No.: 19/568,927

(22) Filed: Mar. 17, 2026

(30) Foreign Application Priority Data
Mar. 19, 2025 (JP) 2025-045105

(51) Int. Cl. G06Q 30/0601

(52) U.S. Cl. CPC G06Q 30/0625

(57) ABSTRACT

A system includes a processor that is configured to access a database of a commercial facility and acquire product information from the database, analyze the acquired product information by using a generative artificial intelligence model and generate a prompt sentence for supporting product selection, and present, to a user, a proposal for product selection based on the generated prompt sentence.

### CROSS-REFERENCE TO RELATED APPLICATION

This application is based on and claims priority under 35 USC 119 from Japanese Patent Application No. 2025-045105 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional product selection support systems in commercial facilities merely retrieve product information from databases and present the information to users in a static manner, such as lists, simple filters, or keyword search results. In such systems, the user is required to manually interpret large amounts of heterogeneous product data, including prices, specifications, stock status, and other attributes, and then independently decide which products to select. As the number and diversity of products increase, this manual interpretation becomes time-consuming and cognitively burdensome, and the quality and efficiency of product selection deteriorate. Furthermore, existing systems typically do not leverage generative artificial intelligence models to actively assist users by generating context-specific guidance or instructions. In particular, there is insufficient support for dynamically generating prompts that can, for example, optimize database queries for relevant product retrieval or predict user consumption behavior based on past purchase and browsing histories. As a result, product proposals remain generic and are not adequately tailored to the user's latent needs or consumption patterns. Therefore, there is a need for a system that can access a commercial facility database, analyze acquired product information using a generative artificial intelligence model, and generate prompts that effectively support product selection, including prompts for query optimization and prompts for predicting user consumption behavior, thereby providing more accurate and personalized product proposals to the user.

### SUMMARY

To solve the above-described problems, according to one aspect of the present invention, there is provided a system comprising a processor, wherein the processor is configured to access a database of a commercial facility and acquire product information from the database, analyze the acquired product information by using a generative artificial intelligence model, and generate a prompt sentence for supporting product selection. The processor is further configured to present, to a user, a proposal for product selection based on the generated prompt sentence. In one embodiment, the processor is configured to generate a prompt sentence for instructing optimization of a database query, such that the generative artificial intelligence model can refine or reformulate database queries to retrieve more relevant product information in response to user context or intent. In another embodiment, the processor is configured to analyze a past purchase history and a browsing history of the user and to generate a prompt sentence for instructing prediction of a consumption behavior of the user, such that the generative artificial intelligence model can infer future purchase tendencies and preferences. By combining these functions, the system automatically generates prompts that guide both database query optimization and user behavior prediction, and uses the outputs of the generative artificial intelligence model to provide tailored product selection proposals, thereby reducing the burden on the user and improving the accuracy and efficiency of product selection.

The term “system” refers to an arrangement of one or more hardware and software components that cooperate to perform the processing described in the claims, including at least a processor and, optionally, memory, storage, communication interfaces, and external services.

The term “processor” refers to any hardware device or combination of hardware devices capable of executing instructions, such as a central processing unit (CPU), a graphics processing unit (GPU), a digital signal processor (DSP), an application-specific integrated circuit (ASIC), a field-programmable gate array (FPGA), or a cloud-based computing resource.

The term “commercial facility” refers to any physical or virtual establishment that offers products for sale to customers, including but not limited to supermarkets, retail stores, shopping malls, online marketplaces, and e-commerce platforms.

The term “database” refers to any structured or semi-structured data storage system that stores product information and can be accessed by the processor through a query or an application programming interface.

The term “product information” refers to data associated with products managed by the commercial facility, including at least one of product identifiers, names, categories, prices, specifications, stock status, descriptions, and other attributes relevant to product selection.

The term “generative artificial intelligence model” refers to a machine-learned model configured to generate text, prompts, or other content based on input data, and includes, for example, large language models and other generative models trained on sample data.

The term “prompt sentence” refers to a text or text-like data structure generated by the processor for input to a generative artificial intelligence model or for presentation to a user, the text including instructions, queries, or contextual information for supporting processing related to product selection, database queries, or consumption behavior prediction.

The term “supporting product selection” refers to assisting the user or another system in choosing one or more products from among multiple candidate products, for example by narrowing down candidates, highlighting relevant products, or generating recommendations.

The term “proposal for product selection” refers to information presented to the user that suggests or recommends one or more products to be selected, including, for example, a ranked list of products, highlighted items, or explanations for why certain products are suggested.

The term “optimization of a database query” refers to improving the structure or content of a query to the database so as to increase relevance, accuracy, or efficiency of retrieved product information, including reformulating search terms, adding or modifying conditions, or changing query parameters based on context.

The term “past purchase history” refers to recorded data indicating which products the user has previously purchased, including at least product identifiers, quantities, prices, time of purchase, and optionally store information.

The term “browsing history” refers to recorded data indicating which products or product-related pages the user has viewed or interacted with, including at least product identifiers, timestamps, and types of interactions.

The term “consumption behavior” refers to a pattern or tendency of the user's product-related actions over time, including frequency, timing, and types of products purchased or viewed, which can be used to predict future product preferences or purchase intentions.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

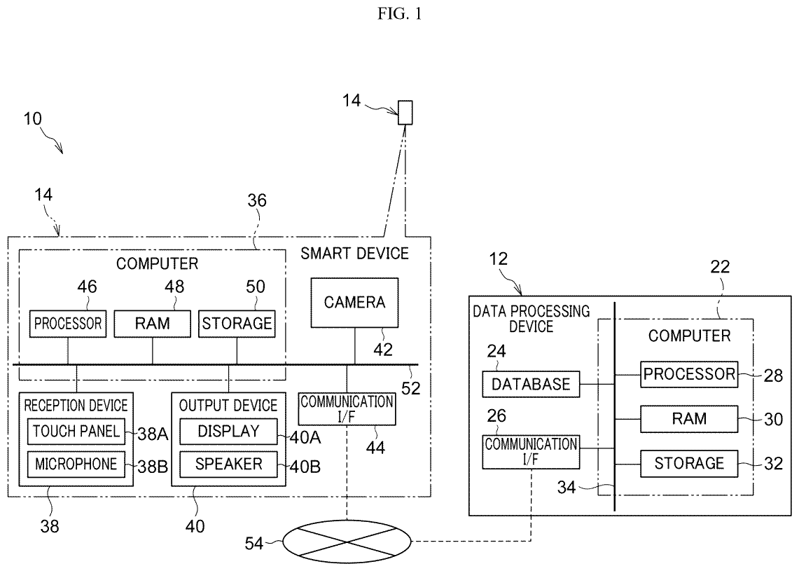

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

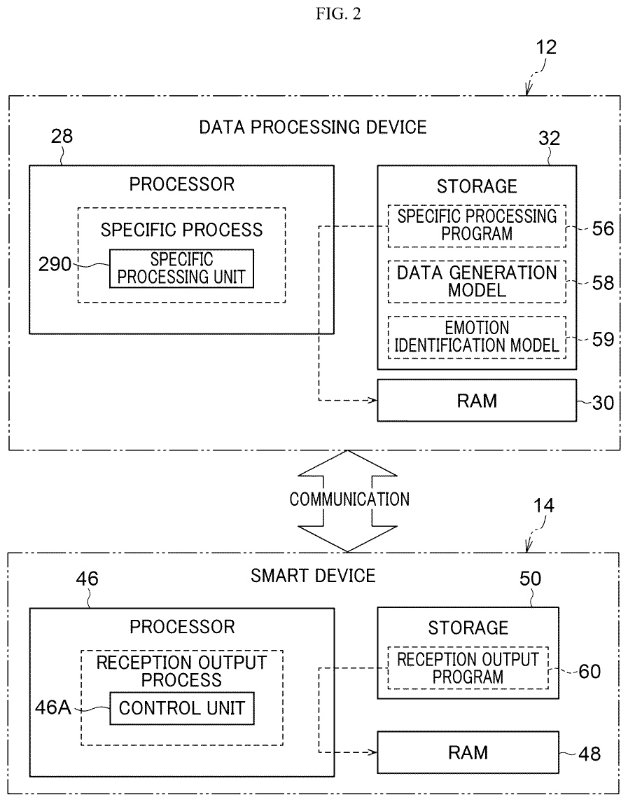

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60.

The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58.

The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented product recommendation systems suffer from several technical limitations in how they acquire, store, and process item data and user behavior data, and in how they generate explanations to assist user decision-making. First, existing systems typically retrieve product records from a commercial database using fixed query expressions and simple attribute filters. As a result, server-side processing does not adapt to changing query load, response-time constraints, or user-specific selection conditions, which can cause unnecessary database traffic, increased latency, and inefficient use of computing resources when handling large-scale structured product data.

Second, conventional systems generally treat user purchase history and browsing history as static preference labels or simplistic scores, without extracting higher-level preference feature values or behavior tendencies that can be reused across multiple queries. Because the server does not maintain or exploit a structured user profile derived from behavior history, the system cannot efficiently compute ranking indices or preference suitability degrees for many candidate items in real time, which degrades responsiveness and scalability, particularly when the number of items and users is large.

Third, prior systems usually present product lists and basic attribute values directly to a terminal without generating context-aware explanation sentences or proposal sentences that take into account both detailed item attributes and individualized user behavior patterns. Although some systems may incorporate a generative AI model, such models are often invoked with ad hoc or minimally structured input, which underutilizes the model's ability to reason over complex, structured item data. In particular, conventional approaches lack a mechanism in which the server constructs a composite prompt sentence that embeds machine-readable context information, such as extraction results and calculated unit-quantity prices, ranking indices, and preference suitability degrees, in a systematic and repeatable manner.

Fourth, because the server does not dynamically generate prompt sentences that specify query optimization conditions based on real-time database load, response time, and user selection conditions, existing architectures cannot adapt query generation and execution strategies to current system states. This can cause suboptimal query planning at the database layer, including unnecessary full-table scans and inefficient index usage, leading to increased latency and reduced throughput for concurrent users.

Accordingly, there is a need for computer technology that improves how a server: (i) acquires sales target information from a commercial transaction site and stores it in a structured information storage mechanism, (ii) executes aggregation and evaluation processing to compute derived metrics such as unit-quantity prices, ranking indices, and preference suitability degrees, (iii) derives preference feature values and behavior tendencies from user purchase and browsing histories and incorporates them into a structured profile, (iv) generates composite prompt sentences that combine context information and natural-language instructions for input to a generative information processing model, and (v) uses prompt sentences that represent query optimization conditions to control database query expressions. By addressing these technical problems, the invention aims to reduce processing latency, improve resource utilization, enhance the accuracy and relevance of product selection proposals, and provide a more efficient and technically improved human-computer interaction in the context of item selection.

The specific processing by the specific processing unit 290 of the data processing device 12 in Example 1 is realized by the following means.

The present invention provides a server comprising a processor configured to access an information providing mechanism of a commercial transaction site, acquire a set of sales target information, store the acquired set of sales target information in a structured information storage mechanism, and execute aggregation processing and evaluation processing based on price attributes, quality attributes, origin attributes, dimension attributes, mass attributes, and appearance attributes of the sales targets; the processor further configured to extract sales targets based on selection conditions of a user and behavior history information of the user and to calculate, for the extracted sales targets, at least a unit-quantity price, a ranking index, and a preference suitability degree; the processor further configured to generate a composite prompt sentence including context information comprising an extraction result of the sales targets and calculated results of the unit-quantity price, the ranking index, and the preference suitability degree, and an instruction sentence in natural language for input to a generative information processing model, and to transmit the composite prompt sentence to the generative information processing model to cause the generative information processing model to generate an explanation sentence or a proposal sentence relating to product selection; the processor further configured to generate response information by associating the explanation sentence or the proposal sentence obtained from the generative information processing model with the extraction result and to transmit the response information to a communication terminal; and the processor further configured to generate, based on a load and a response time of a query to the structured information storage mechanism and the selection conditions of the user, a prompt sentence indicating query optimization conditions and to control a query expression used to extract the sales targets in accordance with the query optimization conditions. This enables an improved computer-implemented product selection support process in which database access is adaptively optimized, user-specific ranking and preference suitability metrics are efficiently computed, and a generative information processing model is provided with structured composite prompts that integrate context information and user profiles, thereby reducing processing latency, improving utilization of storage and computation resources, and generating more accurate and personalized explanation sentences and proposal sentences for presentation on the communication terminal.

The term “system” refers to a combination of one or more hardware components and software components that cooperate to execute information processing, including at least a server-side processor and a communication terminal.

The term “processor” refers to one or more hardware processing units, such as a central processing unit or a processing circuit, configured to execute instructions stored in a memory to perform the functions described herein.

The term “communication terminal” refers to an electronic device operated by a user, including at least an input interface, a communication interface, and a display device, and configured to send requests to and receive responses from the server.

The term “display device” refers to a hardware component capable of visually outputting information, such as a liquid crystal display, an organic light emitting diode display, or a projection display.

The term “information providing mechanism” refers to a hardware and software interface, such as an application programming interface or a web service, that enables external systems to access data managed by a commercial transaction site.

The term “commercial transaction site” refers to a physical or virtual environment, including an online service or a physical store system, that manages and provides information regarding items or services offered for sale.

The term “sales target” refers to an item or a service that is offered for sale by the commercial transaction site and for which attribute information is managed.

The term “sales target information” refers to structured or semi-structured data describing one or more sales targets, including at least identifiers and attribute values such as price, quality, origin, dimensions, mass, and appearance.

The term “set of sales target information” refers to a collection of sales target information entries acquired from the commercial transaction site, typically corresponding to multiple sales targets within one or more categories.

The term “structured information storage mechanism” refers to a data storage subsystem, such as a database management system or a structured data store, configured to store and retrieve structured data according to a predefined schema.

The term “aggregation processing” refers to processing that computes summarized or combined values from multiple records of sales target information, such as averages, minimums, maximums, counts, or grouped statistics.

The term “evaluation processing” refers to processing that computes assessment values or scores for one or more sales targets based on their attributes, including calculation of derived metrics such as unit-quantity prices, ranking indices, and preference suitability degrees.

The term “price attribute” refers to a data value that represents a cost or selling price associated with a sales target, including, for example, a total price, a price per unit, or a discount price.

The term “quality attribute” refers to a data value that indicates a condition or freshness or grade of a sales target, such as a freshness score, a quality rank, or a best-before date.

The term “origin attribute” refers to a data value indicating a source or provenance of a sales target, such as a production region, a country of origin, or a manufacturing facility identifier.

The term “dimension attribute” refers to a data value representing a physical size of a sales target, including one or more measurements such as length, width, height, or volume.

The term “mass attribute” refers to a data value representing a weight or mass of a sales target, such as a mass in grams, kilograms, or another physical unit.

The term “appearance attribute” refers to a data value that characterizes a visual property of a sales target, such as color, color tone, pattern, or other visually perceivable features.

The term “selection conditions of a user” refers to constraints or preferences specified by the user or derived from the user profile, including, for example, a desired category, acceptable price range, minimum quality level, or preferred origin.

The term “behavior history information” refers to data representing past actions of a user in relation to sales targets, including at least purchase history information and browsing history information.

The term “purchase history information” refers to records of items or services purchased by a user, including identifiers of purchased sales targets, purchase times, quantities, and prices.

The term “browsing history information” refers to records of viewing or interaction events by a user with respect to sales targets, including viewed items, search queries, clicks, or time spent on item pages.

The term “unit-quantity price” refers to a value calculated by dividing a price of a sales target by a standardized quantity, such as weight, volume, or piece count, to normalize prices for comparison.

The term “ranking index” refers to a numerical or ordinal value computed for each sales target to indicate a relative order among multiple sales targets according to one or more criteria such as price, quality, and user preference.

The term “preference suitability degree” refers to a value that quantifies how well a sales target matches estimated preferences or behavior tendencies of a user, based on a comparison between item attributes and a user profile.

The term “context information” refers to structured data that describes a situation in which a generative information processing model is used, including at least extraction results for sales targets and associated calculated metrics.

The term “extraction result” refers to a subset of sales targets selected from the set of sales target information based on selection conditions of the user and behavior history information of the user.

The term “instruction sentence in natural language” refers to a sequence of words in a human language that instructs a generative information processing model to perform a specific processing task, such as generating an explanation or a proposal.

The term “composite prompt sentence” refers to a prompt structure that combines context information with at least one instruction sentence in natural language for input to a generative information processing model.

The term “prompt sentence” refers to a text input composed in natural language or a mixed format that is provided to a generative information processing model in order to cause the model to generate an output.

The term “generative information processing model” refers to a machine-learned model, such as a generative AI model, configured to generate text or other content based on input token sequences, including prompt sentences and context information.

The term “explanation sentence” refers to natural-language output generated by the generative information processing model that describes reasons, comparisons, or interpretations related to one or more sales targets.

The term “proposal sentence” refers to natural-language output generated by the generative information processing model that suggests one or more sales targets or actions for the user based on the context information and user profile.

The term “response information” refers to data generated by the processor that associates at least an explanation sentence or a proposal sentence with an extraction result of sales targets and that is transmitted to the communication terminal.

The term “query optimization condition” refers to metadata or parameters that specify how a query to the structured information storage mechanism should be adjusted or planned to improve performance with respect to load, response time, or resource consumption.

The term “query expression” refers to a representation of a database request, such as a structured query language statement or a parameterized query description, used to retrieve or manipulate data in the structured information storage mechanism.

The term “load of a query” refers to a measure of computing resource usage or impact caused by executing a query, including factors such as CPU utilization, memory usage, disk I/O, and network traffic.

The term “response time of a query” refers to a time interval measured from submission of a query expression to the structured information storage mechanism until reception of a corresponding result.

The term “preference feature values” refers to quantitative or qualitative parameters derived from behavior history information of the user, representing stable preferences such as typical price range, desired quality level, or favored origin.

The term “behavior tendencies” refers to patterns inferred from behavior history information of the user, such as frequency of purchases, typical time of purchases, or consistent choice patterns among attributes.

The term “profile information” refers to a structured representation of the user that includes at least preference feature values and behavior tendencies and is used in processing by the processor and the generative information processing model.

In one embodiment, a server implements the claimed system using one or more general-purpose computers equipped with a central processing unit, a main memory, a network interface, and a non-volatile storage device. The server executes software components including an operating system such as a general-purpose server operating system, an application server framework such as a web application framework, a database management system such as a relational database system, and an HTTP client library such as a generic HTTP request library. The server further accesses a generative AI model that is deployed on one or more computation nodes including graphics processing units, and that is implemented as a transformer-based neural network.

The server uses a network interface to access an information providing mechanism of a commercial transaction site. The server establishes an HTTPS connection and transmits authenticated requests using an API key stored in a secure storage area of the non-volatile storage device. The server receives a set of sales target information in a structured text format, such as a JSON-formatted text. The server maps the received attributes to internal data structures, such as in-memory objects containing fields for price attributes, quality attributes, origin attributes, dimension attributes, mass attributes, and appearance attributes.

The server writes the mapped data into tables of the relational database system, for example into a product table with columns representing identifiers, numeric price values, freshness scores, region codes, dimensional measurements, mass values, and color codes.

The server performs aggregation processing and evaluation processing by executing SQL queries and in-memory computations. The server computes aggregated statistics such as average price per category, minimum and maximum freshness scores per store, and histograms of mass distributions. The server calculates evaluation metrics such as a normalized price score, a normalized freshness score, and a composite quality score that is a weighted sum of multiple attributes. The server stores the results of these computations in auxiliary tables or materialized views to reduce computation time for subsequent queries. By precomputing and indexing these evaluation metrics, the server reduces the number of full-table scans and improves query latency when responding to user requests.

The server maintains behavior history information for each user in dedicated tables. The server writes purchase history records that include a user identifier, a product identifier, a timestamp, a purchased quantity, and a paid price. The server also writes browsing history records that include viewed product identifiers, timestamps of viewing events, and interaction types such as clicks, scroll depth, or dwell time. The server periodically analyzes these records using batch processing jobs implemented, for example, in a general-purpose programming language. The server derives preference feature values such as a preferred price range, a preferred origin region, a minimum acceptable freshness score, and a typical mass range. The server also computes behavior tendencies such as purchase frequency, time-of-day patterns, and a tendency to favor certain categories.

The server stores the derived preference feature values and behavior tendencies in a user profile table. The server uses this table to compute, for each candidate sales target, a preference suitability degree. The server calculates the preference suitability degree by comparing item attributes to preference feature values using a similarity function, such as a weighted distance function over normalized attribute spaces. For example, the server computes a price similarity score based on the difference between an item's unit-quantity price and the user's preferred price range, and computes an origin match score based on whether the item's origin attribute is included in a set of preferred origins. The server combines these partial scores into a single preference suitability degree using predetermined weights stored in a parameter table. This explicit computation within the server allows the system to perform ranking and filtering operations in a deterministic, inspectable manner and to tune weights for computational efficiency.

The server generates a composite prompt sentence for a generative AI model by constructing a text that includes both context information and an instruction sentence in natural language.

The server assembles the context information by serializing the extraction result of candidate sales targets and their associated unit-quantity prices, ranking indices, and preference suitability degrees into a compact textual representation. For example, the server formats the context as a list of items, each line containing an item identifier, a normalized price value, a freshness score, and a preference suitability degree. The server then appends an instruction sentence that directs the generative AI model to use this context to generate an explanation or a proposal.

The server may, for example, generate the following prompt sentence:

“Based on the following item list with price, freshness, origin, size, weight, and preference scores, please explain which items are most suitable for a user who wants fresh tomatoes for a salad today, and provide a clear recommendation.”

The server may also forward a user-entered instruction sentence as part of the composite prompt. For instance, when the user enters:

“Please tell me the price, freshness, origin, size, weight, and color tone of tomatoes sold at nearby supermarkets and recommend the best option for making a salad today.” the server combines this prompt sentence with the structured context describing the candidate items. By explicitly embedding machine-generated metrics and identifiers into the prompt, the server supplies the generative AI model with structured constraints and numeric features that are not typically considered in human-only decision processes.

The server uses a generative AI model implemented as a multi-layer transformer neural network. The model includes an embedding layer for token representations, a sequence of self-attention blocks, and a final linear projection layer to produce token probabilities. The server accesses the model either via an external inference service or as an internal service deployed on hardware accelerators such as graphics processing units. The neural network is trained offline using a corpus that includes instruction-response pairs in which the input contains structured item descriptions and the output contains explanations and recommendations. The training procedure minimizes a cross-entropy loss between the predicted token sequence and reference responses. During training, the model parameters (weights and biases) are updated using a gradient-based optimization algorithm, such as stochastic gradient descent with adaptive learning rate scheduling. Training data augmentation techniques, such as paraphrasing of instructions, random reordering of list items, and masking of non-critical attributes, may be applied to improve robustness.

The server configures inference parameters for the generative AI model, including maximum output length, temperature, and top-k or top-p sampling thresholds. The server selects these parameters to balance generation diversity with determinism and latency constraints. Because the server passes structured numeric features alongside natural-language descriptions, the model can apply internal learned attention patterns that correlate particular tokens (such as price numbers) with instruction tokens (such as “cheapest,” “freshest,” or “best balance”).

This structured prompt design improves the model's ability to generate consistent, attribute-aware recommendations and reduces the need for post-processing on the server side.

The server improves computer technology by integrating dynamic query optimization with AI-based explanation generation. The server monitors a load and a response time of queries executed against the structured information storage mechanism by sampling metrics from the database management system, including query execution time, number of scanned rows, cache hit ratios, and CPU utilization. The server converts these metrics into query optimization conditions, such as limiting the number of returned rows, adjusting filter thresholds, or preferring certain index paths. The server then generates a prompt sentence that encodes these query optimization conditions and passes it to a query planning component within the application. The server uses this prompt sentence as a control directive to modify query expressions, for example by adding range constraints or by replacing a full scan with an index-based lookup. As a result, the server reduces query latency and memory consumption, particularly when processing repeated or similar queries across many users.

The server also generates prompt sentences that describe desired ranking behavior and selection criteria for the generative AI model in a non-conventional way. Instead of instructing the model to simply pick the “cheapest” or “freshest” item, the server provides explicit rules as natural-language constraints. For example, the server may include in the composite prompt text such as:

“Do not select items that have a freshness score below 70. Prefer items whose unit price is less than 1.2 times the minimum unit price, and whose preference suitability degree is above 0.8. If there is a trade-off, explain why you choose a more expensive but fresher product.” These non-standard instructions allow the model to follow rule-like behavior that is difficult for human users to apply consistently when processing large lists. The server thereby uses the model to implement a complex decision policy that would otherwise require manually coded rule engines, reducing development complexity while improving adaptability.

The terminal operates as a communication terminal with a display device. The terminal executes client-side software such as a web browser or a native application framework. The terminal establishes HTTPS connections to the server via a network interface. The terminal receives response information that includes the extraction result of sales targets and the explanation or proposal sentences generated by the generative AI model. The terminal renders the sales target information as visual elements, such as cards displaying the item name, price, freshness indicator, origin text, dimension labels, mass values, and color swatches. The terminal uses a layout engine, cascading style sheets, and a graphics rendering pipeline to draw lists, charts, and badges. The terminal associates the explanation or proposal sentences with highlighted items, for example by placing the recommendation text adjacent to recommended cards or by visually marking recommended items with a “Recommended” label.

The terminal provides an input interface that allows the user to specify selection conditions and prompt sentences. The user uses input devices such as a touchscreen, keyboard, or pointing device to enter search terms, select categories, adjust sliders for price and freshness range, and type free-form questions. The terminal sends these user inputs to the server as HTTP requests with encoded parameters. When the user enters a natural-language prompt sentence, such as:

“I want to buy cheap but reasonably fresh tomatoes. Based on the available data, which products offer the best balance between low price and acceptable freshness?”
the terminal forwards the text to the server without modification, together with context such as selected category and store. The terminal then displays the model's response, allowing the user to understand complex trade-offs between items without manually inspecting each attribute.

The terminal and the server together improve the data management and visualization pipeline. The server reduces the volume of data sent to the terminal by pre-filtering and ranking items based on computed metrics and by transmitting only the top-ranked subset.

This design reduces network bandwidth usage and client-side rendering costs. The terminal then applies lightweight rendering and only needs to process a limited number of items, improving responsiveness and reducing power consumption on mobile devices.

The generative AI model is not merely automating a human mental process; instead, the server coordinates the model with structured data processing components to improve the performance of the computer system as a whole. The server uses the model to compress complex multidimensional comparisons into short natural-language explanations. The server thereby reduces the number of round-trip queries and the need for repeated client-side filtering. Because the server precomputes unit-quantity prices, ranking indices, and preference suitability degrees, and includes them explicitly in prompts, the model's internal attention mechanism operates over normalized, machine-curated features rather than raw textual descriptions only. This reduces the variance in generated outputs and allows the system to meet strict latency and accuracy constraints under high load.

In another embodiment, the server deploys multiple generative AI models with different sizes or parameter counts. The server selects a smaller model when the number of candidate items is small or when response-time constraints are strict, and selects a larger model when the user explicitly requests highly detailed explanations. The server uses a routing algorithm based on real-time load metrics and user requirements to choose the model endpoint. This multi-model arrangement further improves computational efficiency and scalability.

In still another embodiment, the server employs a hybrid rule-based and model-based approach. The server first applies deterministic rules to discard items that clearly do not meet essential constraints, such as exceeding maximum price or failing minimum freshness thresholds. The server then uses the generative AI model only for the remaining subset of items to generate nuanced explanations. This layered architecture reduces the number of tokens that must be processed by the model, thereby minimizing inference time and computational cost on the accelerator hardware.

In all embodiments, the server and the terminal cooperate to implement the functions recited in the claims, including acquisition of sales target information, storage in a structured information storage mechanism, computation of unit-quantity prices, ranking indices, and preference suitability degrees, generation of composite prompt sentences for a generative AI model, dynamic adjustment of query expressions based on query optimization conditions, and visual presentation of recommended items and explanations to the user. The described configurations and variations show how the claimed system can be realized on existing computer hardware and software platforms and how it improves computer technology by reducing query latency, optimizing resource utilization, enhancing data management, and enabling more accurate and personalized product selection support.

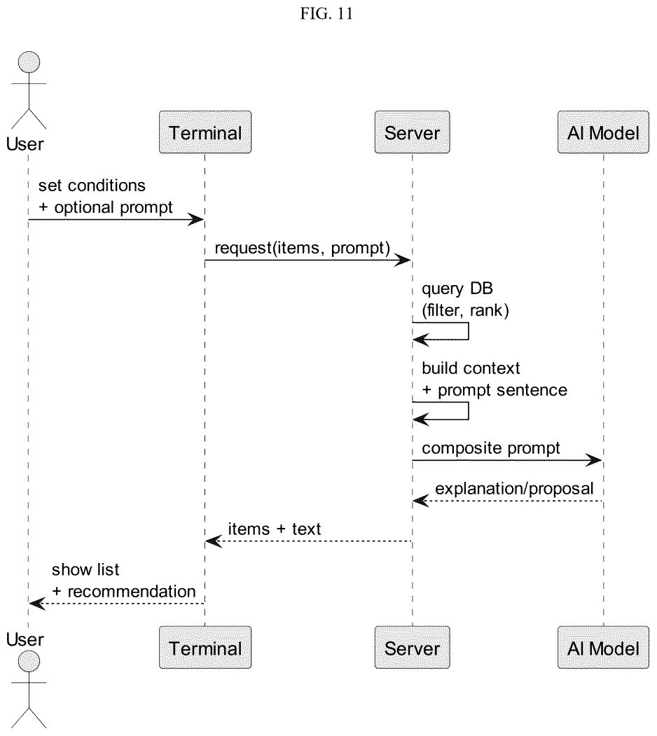

The following describes the processing flow using FIG. 11.

### Step 1:

The server initializes system configuration.

The server reads configuration files from storage as input, including API endpoint URLs, authentication keys, database connection strings, and generative AI model endpoint parameters.

The server parses these configuration values, validates formats (for example, URL syntax and key lengths), and stores the processed values in in-memory configuration objects as output.

The server establishes a connection pool to a structured information storage mechanism, such as a relational database, and initializes HTTP client modules for later communication with the commercial transaction site and the generative AI model.

### Step 2:

The server acquires raw sales target information from a commercial transaction site.

The server receives as input the API endpoint URL, an API key, and request parameters such as item category, store identifier, and pagination tokens.

The server constructs an HTTPS request, adds the API key in a header, and transmits the request to the information providing mechanism. The server then receives a response body in a structured text format, for example JSON, that contains multiple sales target records as output.

The server checks the HTTP status code and content type, and if valid, passes the JSON text to a parsing module.

### Step 3:

The server parses and normalizes the acquired sales target information.

The server uses the JSON text containing raw item records as input.

The server decodes the JSON into in-memory objects, extracts fields such as item identifiers, price values, freshness indicators, origin codes, dimension values, mass values, and color descriptors, and converts them into normalized data types, for example floating-point numbers for prices and mass, and standardized codes for origin and color.

The server outputs normalized item objects and discards or logs records that lack required attributes.

### Step 4:

The server stores the normalized sales target information in the structured information storage mechanism.

The server takes the normalized item objects as input.

The server maps each object field to columns in a product table, constructs parameterized SQL INSERT or UPDATE statements, and executes them through the database connection pool. During this data operation, the server also updates indexes on key columns such as category, store identifier, and freshness score.

The server outputs a set of stored records in the database and index structures that are ready for efficient querying.

### Step 5:

The server performs aggregation processing and evaluation processing over stored sales target information.

The server uses as input the product table records stored in the database.

The server executes SQL aggregation queries that compute average prices, minimum and maximum freshness scores, and distribution statistics per category and per store, and then computes evaluation metrics such as normalized price scores and normalized freshness scores by applying linear scaling or other normalization functions.

The server outputs updated records with attached evaluation fields or separate tables storing these metrics, which are used to accelerate later ranking operations.

### Step 6:

The server maintains and updates behavior history information for each user.

The server receives as input user interaction events sent from the terminal, such as purchase confirmations, product views, and clicks on item details.

The server writes purchase history entries with user identifiers, item identifiers, timestamps, quantities, and prices into a purchase history table, and writes browsing history entries with viewed item identifiers, timestamps, and event types into a browsing history table.

The server outputs updated behavior history tables that reflect the latest user actions.

### Step 7:

The server derives preference feature values and behavior tendencies from behavior history information.

The server uses purchase history records and browsing history records for a particular user as input.

The server computes statistics such as median and variance of unit-quantity prices, most frequently selected origin regions, typical freshness levels of purchased items, and time-of-day purchase frequencies. The server then converts these statistics into preference feature values (for example, preferred price range and minimum acceptable freshness) and behavior tendencies (for example, high-frequency buyer or preference for a certain category).

The server outputs a user profile entry containing the derived preference feature values and behavior tendencies and stores it in a user profile table.

### Step 8:

The user specifies selection conditions and optionally a natural-language prompt sentence.

The user uses the terminal interface as input hardware to select item categories, price ranges, freshness thresholds, and preferred attributes via graphical controls, and optionally types a free-form text question, such as a prompt sentence asking for a recommendation.

The user submits these inputs through the terminal's user interface controls, triggering a request to be sent to the server.

The user's actions result in a set of explicit selection conditions and an optional prompt sentence that the terminal can forward to the server.

### Step 9:

The terminal transmits selection conditions and optional prompt sentence to the server.

The terminal receives as input the user's selected category, numerical filter values, and any entered prompt sentence text.

The terminal serializes this data into an HTTP request, for example including query parameters for filters and a request body field containing the prompt sentence, and transmits the request over HTTPS to the server endpoint.

The terminal outputs a structured request message that is received by the server.

### Step 10:

The server extracts candidate sales targets based on selection conditions and user profile.

The server uses as input the selection conditions from the terminal and the user profile entry stored in the user profile table.

The server constructs a query expression that filters items by category, price range, freshness threshold, and any other hard constraints, and executes the query against the product table.

The server then reorders or filters the query results by comparing item attributes with preference feature values, thereby eliminating items that significantly deviate from the user's preferences.

The server outputs a subset of sales targets, called the extraction result, which comprises candidate items to be considered for ranking and recommendation.

### Step 11:

The server computes unit-quantity prices, ranking indices, and preference suitability degrees for the extracted sales targets.

The server uses as input the extraction result items and the preference feature values from the user profile.

The server calculates unit-quantity prices by dividing each item's price by an appropriate quantity measure, such as mass or volume. The server calculates a ranking index using a weighted formula that combines normalized price scores, freshness scores, and other evaluation metrics. The server computes a preference suitability degree by applying a similarity function between item attributes and preference feature values, producing a score between predetermined bounds.

The server outputs an augmented extraction result where each item is annotated with its unit-quantity price, ranking index, and preference suitability degree.

### Step 12:

The server generates context information from the augmented extraction result.

The server uses the augmented extraction result as input.

The server selects a limited number of top-ranked items to reduce data volume, then serializes these items into a compact textual representation, for example listing each item identifier together with numeric values for unit-quantity price, freshness, and preference suitability degree, and brief textual summaries of origin and dimensions.

The server outputs a context information text block that will be embedded into a composite prompt sentence.

### Step 13:

The server constructs a composite prompt sentence for a generative AI model.

The server uses as input the context information text block and an instruction sentence in natural language, which may be generated by the server or received from the user via the terminal.

The server concatenates the context information and the instruction sentence into a prompt structure, optionally including rule-like guidance such as thresholds for freshness and acceptable price multiples. For example, the server may construct a prompt including text such as:

“Do not select items that have a freshness score below a specified value. Prefer items whose unit price is less than a particular multiple of the minimum unit price and whose preference suitability degree exceeds a threshold.”

The server outputs the composite prompt sentence as a single text input ready for submission to the generative AI model.

### Step 14:

The server transmits the composite prompt sentence to the generative AI model and obtains generated text.

The server uses as input the composite prompt sentence and model configuration parameters, such as maximum output length and sampling temperature.

The server sends an HTTPS POST request to an inference endpoint hosting the generative AI model, providing the composite prompt sentence as the model's input sequence. The generative AI model executes internal neural network computations and returns a generated text sequence that contains an explanation sentence and/or a proposal sentence regarding product selection.

The server outputs the generated explanation or proposal text as model output.

### Step 15:

The server generates response information associating generated text with extracted items.

The server uses as input the augmented extraction result and the generated explanation or proposal text.

The server analyzes the generated text to detect references to particular item identifiers or positions if such information is provided, and links each recommended item to corresponding parts of the text. The server then constructs a response object containing the list of candidate items with their computed metrics and a dedicated field holding the text explanation or proposal.

The server outputs response information ready to be sent to the terminal.

### Step 16:

The terminal receives the response information and prepares visual presentation data.

The terminal uses the response information from the server as input.

The terminal parses the item list and associated metrics, then maps them to visual components such as cards, tables, and chart data series. The terminal also extracts the explanation or proposal sentence text and assigns it to a designated display area.

The terminal outputs an internal UI representation that instructs the rendering engine how to draw the visual elements and where to display the generated text.

### Step 17:

The terminal visually presents the sales target information and generated explanation or proposal to the user.

The terminal uses the prepared UI representation as input.

The terminal renders product cards that show item names, prices, unit-quantity prices, freshness indicators, origins, dimensions, mass values, and appearance indicators such as color labels. The terminal highlights items with high ranking indices or preference suitability degrees using color coding or icons. The terminal displays the explanation or proposal sentence near the highlighted items, for example in a recommendation panel, thereby associating the natural-language output with specific items.

The terminal outputs a graphical user interface on the display device that allows the user to visually interpret the recommendations.

### Step 18:

The user reviews the recommended items and explanation, and may refine selection conditions or prompt sentence.

The user uses the terminal display and input controls as input to their decision process.

The user reads the explanation or proposal sentence, inspects highlighted items and their metrics, and, if desired, modifies filters, such as narrowing the price range or increasing a minimum freshness threshold, or enters a new prompt sentence, for example asking for items suitable for a different cooking use.

The user's actions produce updated selection conditions and/or a new prompt sentence, which can be sent again by the terminal to the server, thereby repeating and refining the processing flow.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented shopping assistance systems typically retrieve product information from a database and present static lists or simple overlays on a display device. In such systems, the processor generally executes fixed query logic against a product database and renders predetermined user interface elements. These approaches suffer from several technical limitations.

First, existing systems do not efficiently integrate real-time object recognition in a dynamic physical environment with database access. The processor frequently performs redundant or sub-optimal queries because it lacks a mechanism to adapt query formulation to the specific product context and user context. This can lead to increased processing load on the database, higher network traffic, and latency in delivering product information to the user, thereby degrading system responsiveness in resource-constrained environments such as mobile and wearable platforms.

Second, conventional systems typically decouple user behavior modeling from the real-time presentation pipeline. Even when past browsing or transaction history is stored, the processor often uses simple rule-based or heuristic techniques that do not exploit the accumulated behavior data to dynamically tailor the information retrieval and presentation process. As a result, the system cannot effectively prioritize or filter database access and AR overlays in a way that reflects the user's consumption behavior, leading to unnecessary computations and an overloaded visual interface on the wearable display device.

Third, known systems using generative models often employ such models merely as a front-end content generator, without deeply integrating the generative capabilities into the core control flow of database interaction and user interface control. In particular, existing architectures do not utilize prompt sentences as machine-interpretable control artifacts for optimizing query execution plans or for coordinating cross-facility selection, payment, and delivery operations. Consequently, the processor cannot leverage generative models to improve internal computer operations such as query selection, scheduling, and coordination of multiple back-end services.

Fourth, augmentation of reality on a wearable display device is usually achieved by statically overlaying labels or icons on camera images. However, such overlays are not generated based on a unified model that jointly considers (i) real-time object recognition results, (ii) structured product attribute information, and (iii) a behavior model learned from user history, all coordinated through a generative model. This lack of integrated processing results in inefficient rendering decisions, increased cognitive load on the user, and sub-optimal use of the limited display area and computational resources of the wearable device.

Accordingly, there is a need for an improved computer-implemented system and processing method in which a processor coordinates imaging, recognition, database access, behavior modeling, and generative AI processing in a unified manner. Such a system should use prompt sentences not merely to generate natural-language output, but also as internal control signals to optimize database queries and to generate AR overlays that adapt to the user's behavior model and current field of view. By doing so, the system should improve the efficiency, responsiveness, and adaptability of computer operations involved in real-time shopping assistance on wearable platforms.

The specific processing by the specific processing unit 290 of the data processing device 12 in Application Example 1 is realized by the following means.

The present invention provides a server comprising a processor configured to access, via a communication network, an information storage device provided in a plurality of commercial facilities and acquire product attribute information based on product identification information, acquire an image captured by an imaging device mounted on a wearable display device, recognize a product object included in the image by using an image processing program, and generate the product identification information based on a result of the recognition, control display of the wearable display device so as to visually present the product attribute information in a state of being superimposed on the image on a display surface of the wearable display device, accumulate behavior history information and transaction history information of a user and generate a behavior model representing a consumption behavior characteristic of the user on the basis of the behavior history information and the transaction history information, generate a prompt sentence to be input to a generative information processing model on the basis of the product attribute information and the behavior model, input the prompt sentence to the generative information processing model, and generate natural language information including proposal content for product selection, control display of the wearable display device so as to present the natural language information, together with the product attribute information, in a state of being superimposed on the image on the display surface of the wearable display device to support selection of a product within a current field of view of the user, and execute, in response to a product selection input from the user, integrated processing of product selection, price payment, and delivery arrangement with respect to the plurality of commercial facilities, and further configured to generate, on the basis of the product identification information and the product attribute information, a prompt sentence for optimizing execution of an inquiry process to the information storage device, input the prompt sentence to the generative information processing model, and generate control information including a control condition or an execution procedure of the inquiry process, and to generate, on the basis of the behavior history information and the transaction history information, a prompt sentence for predicting future consumption behavior of the user, input the prompt sentence to the generative information processing model, and generate natural language information including a prediction result and proposal content for product selection based on the prediction result. This enables the processor to use the generative information processing model not only for user-facing natural-language output, but also as a dynamic controller for database query optimization and multi-facility transaction coordination, thereby improving internal computer operations such as query planning, network usage, and AR rendering decisions, and increasing the efficiency and responsiveness of real-time shopping assistance on a wearable display platform.

The term “system” refers to an arrangement of one or more information processing devices, storage devices, input/output devices, and communication interfaces configured to execute the functions described in the claims as a unified whole.

The term “processor” refers to one or more hardware processing units, such as a central processing unit, a graphics processing unit, or a dedicated processing circuit, configured to execute instructions to perform the functions specified in the claims.

The term “communication network” refers to any wired or wireless data communication infrastructure, including a local area network, a wide area network, or a public network, that enables data exchange between the system and external devices.

The term “information storage device” refers to any electronic storage apparatus, such as a database server, a storage system, or a memory unit, configured to store product attribute information, user history information, or other data used by the system.

The term “commercial facility” refers to any business location or service point at which goods or services are offered, including physical stores, distribution centers, or other transaction points.

The term “product identification information” refers to data that uniquely or quasi-uniquely identifies a product, such as an identifier, a code, or a combination of attributes that allows the system to distinguish one product from another.

The term “product attribute information” refers to structured data describing characteristics of a product, such as price, quality, origin, size, weight, color, stock level, or categorization.

The term “wearable display device” refers to any display apparatus intended to be worn by a user, such as head-mounted displays or glasses-type devices, that can present visual information in association with the user's field of view.

The term “imaging device” refers to any sensor capable of capturing image data, such as a digital camera, an image sensor, or a depth sensor, mounted on or associated with the wearable display device.

The term “image” refers to digital data representing visual information captured by the imaging device, including still images, video frames, or sequences thereof.

The term “image processing program” refers to software instructions executed by the processor to process an image, including operations such as detection, recognition, segmentation, feature extraction, and classification of objects within the image.

The term “product object” refers to a region or element in an image that corresponds to a physical product located within the environment observed by the imaging device.

The term “recognition” refers to processing that identifies the presence, type, or identity of an object in an image, including assigning a product identification information to a detected product object.

The term “display surface” refers to a region of the wearable display device capable of presenting visual content to the user, including transparent or semi-transparent display areas.

The term “superimposed” refers to a state in which computer-generated visual elements are overlaid on, combined with, or registered with an image such that both the image and the added elements are presented together.

The term “behavior history information” refers to data representing user interactions with products or the system over time, including browsing events, viewing durations, selections, and other non-transactional activities.

The term “transaction history information” refers to data representing completed or attempted commercial transactions by the user, including purchased items, quantities, prices, times, and transaction locations.

The term “behavior model” refers to a data structure or set of parameters derived from behavior history information and transaction history information, representing patterns or characteristics of a user's consumption behavior.

The term “consumption behavior characteristic” refers to tendencies or preferences of a user in selecting or purchasing products, such as preferred price ranges, product categories, or quality levels, as inferred by the system.

The term “generative information processing model” refers to a machine learning model, such as a generative AI model, configured to generate output information, including natural language text or control information, based on an input prompt sentence or conditioning data.

The term “prompt sentence” refers to a sequence of characters, tokens, or structured instructions provided as input to the generative information processing model, specifying context, constraints, or tasks that guide the model's output generation.

The term “natural language information” refers to information expressed in a human language, such as sentences or phrases, generated or processed by the system for presentation to the user.

The term “proposal content for product selection” refers to natural language information that recommends, explains, or evaluates one or more products in view of the user's context or preferences.

The term “current field of view” refers to the area of the physical environment that is optically or computationally observable through the imaging device at a given time.

The term “product selection input” refers to any user operation indicating a choice or intended choice of a product, including gestures, touch inputs, voice commands, or other input modalities detected by the system.

The term “price payment” refers to processing related to settlement of a monetary amount for one or more selected products, including communication with payment services or transaction processing systems.

The term “delivery arrangement” refers to processing to organize logistics for transporting selected products to a designated location, including communication with delivery services or logistics management systems.

The term “inquiry process” refers to a sequence of operations for retrieving data from the information storage device, including formulation, transmission, execution, and response handling of database queries or similar requests.

The term “control information” refers to data used to govern execution of computer operations, such as conditions, parameters, or procedures that specify how the inquiry process or other internal processing should be performed.

The term “control condition” refers to one or more criteria, rules, or parameters that determine when, how, or under what constraints a particular process is executed.

The term “execution procedure” refers to an ordered set of steps, instructions, or operations to be performed by the system in carrying out a process such as the inquiry process.

The term “prediction result” refers to data generated by processing behavior history information and transaction history information, indicating an estimated future state or action related to the user's consumption behavior.

The term “plurality of commercial facilities” refers to two or more commercial facilities that are distinct in location, management, or database instance, and that can each provide product attribute information or receive product selection, payment, and delivery instructions from the system.

In one embodiment, a server, a terminal, and a user cooperate to implement the claimed system. The server includes at least one hardware processor, a main memory, a non-volatile storage device, a network interface, and an interface to one or more information storage devices that store product attribute information and user history information. The terminal includes a hardware processor, a memory, a wireless communication interface, an input interface, and an interface to a wearable display device. The wearable display device includes a display surface and an imaging device such as a digital camera.

The server executes application software on an operating system executed by the server processor. The server uses a data management module to access one or more information storage devices that may be implemented as relational database systems or key-value storage systems. The server maintains at least three logical data structures: a product table, a facility table, and a user history table. The product table stores, for each product identification information, a plurality of product attribute fields including price, freshness score, origin code, size parameters, weight value, and color code. The user history table stores behavior history information records, each including a user identifier, a product identifier, a timestamp, a viewing duration, and a viewing context, and transaction history information records, each including a user identifier, a product identifier, a quantity, a price, a facility identifier, and a transaction time.

The terminal executes an augmented-reality application on a mobile operating system executed by the terminal processor. The terminal uses an image processing library such as an open-source computer vision library and, in some implementations, a deep-learning inference runtime such as a lightweight neural network framework. The terminal receives raw image data from the imaging device of the wearable display device. The terminal processor converts the raw sensor format into a standardized color image format, resizes the image to a predetermined resolution, normalizes pixel values, and arranges the pixel values in a multi-dimensional array suitable for input into a convolutional neural network.

The terminal uses a convolutional neural network model trained to detect and classify product objects in camera images. In one example, the terminal employs a single-shot detector architecture with a backbone network similar to a multi-layer convolutional network. The terminal processor performs a forward pass through the network to obtain, for each region of the image, a set of bounding boxes and associated class probabilities. The terminal selects bounding boxes with probabilities exceeding a threshold and discards others. In some embodiments, the terminal performs non-maximum suppression to eliminate overlapping detections. For each selected product object, the terminal extracts a cropped image patch and generates a feature vector using a feature extraction network such as a reduced-size residual network. This feature vector serves as an intermediate representation of the product object and is used as product identification information or as input to a matching algorithm that resolves the product identification information against a reference database.

The server maintains a feature index in an information storage device. The server stores, for each registered product, a reference feature vector computed offline using the same or a compatible feature extraction network. The server uses a vector similarity algorithm such as approximate nearest neighbor search implemented in a vector search library to compare the feature vector from the terminal with stored reference vectors. The server computes distances between the feature vector and candidate vectors and selects one or more product identifiers with the smallest distance values. The server assigns a confidence score based on the distance and returns the product identification information and the score to the terminal.

The server accesses the product table using a data query module. The server forms a query based on the product identification information and retrieves product attribute information including at least a price field, a freshness field, an origin field, a size field, a weight field, and a color field. The server arranges the retrieved values in a fixed-length record structure that can be serialized into a structured response. The server applies encoding schemes to compress frequently used codes such as origin codes and facility codes to reduce transmission size. By using encoded identifiers instead of verbose strings in the internal processing, the server reduces communication load and improves the speed of information transfer to the terminal.

The terminal executes an augmented-reality rendering engine, which may be implemented using a three-dimensional graphics engine. The terminal associates each recognized product object with a virtual anchor in a three-dimensional coordinate system derived from the imaging device pose. The terminal maps the product attribute information fields to formatted text elements and icon elements. The terminal processor computes projection coordinates on the display surface such that each text box is located adjacent to the corresponding product object in the user's field of view. The terminal updates the positions and visibility of these overlays in response to changes in the imaging device pose. By binding product metadata to stable anchors in the camera coordinate system, the terminal prevents jitter and misalignment of overlays, thereby improving the readability and stability of the augmented-reality presentation.

The server accumulates behavior history information and transaction history information for each user. The server uses an offline training module to generate a behavior model representing consumption behavior characteristics of the user. In one embodiment, the server implements a neural network-based recommendation model. The server constructs input feature vectors that include, for each historical interaction, encoded product category identifiers, normalized price values, freshness scores, origin encodings, time-of-day encodings, and facility encodings. The server uses an embedding layer to transform sparse categorical features into dense numeric vectors and concatenates these with continuous features such as normalized price and freshness scores.

The server trains a feedforward neural network with multiple fully connected layers and non-linear activation functions. The server defines a loss function such as cross-entropy for predicting whether the user will select or purchase a given product. The server executes a training loop in which the server computes gradients of the loss with respect to network parameters by backpropagation and updates the parameters using an optimization algorithm such as stochastic gradient descent with momentum or an adaptive gradient method. The server uses mini-batch training with shuffled batches of user history records. The server may apply data augmentation techniques, for example by randomly varying time-of-day encodings or grouping similar products, to increase robustness. The resulting network parameters form a behavior model that encodes tendencies such as preferred price ranges, preferred product categories, and sensitivity to freshness.

The server stores the behavior model parameters and provides an inference module that, given the current product identification information and product attribute information, computes a preference score for that product for the given user. The server uses this score as an input to a generative AI pipeline. In one embodiment, the server uses a generative AI model that is a transformer-based language model. The server does not simply ask the model to “decide” in an abstract way. Instead, the server constructs a prompt sentence that encodes machine-readable control information including explicit product attributes, preference scores, and desired output structure.

The server assembles the prompt sentence using a deterministic template. For example, the server may generate a prompt sentence of the following type:

“You are a recommendation assistant for a user wearing AR smart glasses in a supermarket.

The user often buys medium-sized red apples from a certain region around 150 yen. The user is currently viewing an apple with the following data: price 150 yen, freshness fresh, origin A, size medium, weight 200 g, color red. Generate a short recommendation (max 2 sentences) suitable for AR overlay. Mention price, freshness, and origin, and explain briefly why this product matches the user's past preferences.”

In another example related to query optimization, the server may generate a prompt sentence of the following type:

“Generate an efficient database query strategy to retrieve price, freshness, origin, size, weight, and color for a list of product IDs from multiple facility databases. Minimize the number of network round trips and avoid redundant requests. Output a concise description of the query grouping and caching strategy.”

In still another example related to prediction of future behavior, the server may generate a prompt sentence of the following type:

“Based on the user's history of frequently purchasing fresh medium-priced fruits in the evening, predict what type of fruit the user is likely to buy next when currently looking at apples and oranges. Provide a short explanation in at most 2 sentences, suitable for AR overlay.”

The server represents the prompt sentence as a sequence of tokens and supplies it to the generative AI model through an inference interface. The server specifies generation parameters such as a maximum token count, a temperature value, and a penalty factor for repetition. The generative AI model outputs token sequences representing natural language information including proposal content for product selection or control information for query execution. The server parses the generated result and separates human-readable sentences from machine-oriented hints if the template requires both.

The server uses the generative AI model not merely to replace human text generation, but as an internal control component that influences system behavior. For example, when the generative AI output describes a query grouping strategy, the server automatically configures its data access module to batch product requests by facility, to use cached results for already retrieved product identifiers, and to schedule queries to minimize peak network usage. This dynamic adjustment of query planning based on generative model output results in reduced network load and lower average latency for retrieving product attribute information. The technical effect arises because the server changes the order and grouping of database calls and because the server selects different caching behaviors compared with a fixed heuristic.

Similarly, when the generative AI output includes a ranked description of which attributes are most important to the user, the server uses this information to determine which fields to include in the serialized response to the terminal and how to allocate display space on the wearable display device. For example, if the output indicates that freshness is more critical than price for a particular user in a certain context, the terminal can render freshness indicators with larger font or more prominent icons, while omitting less important fields such as size in crowded scenes. This selective transmission and rendering reduce the data size and processing load for each frame, leading to improved rendering speed and a smaller probability of dropped frames on the resource-constrained terminal.

The terminal uses the generated natural language information to update the overlays on the display surface. The terminal arranges the proposal content for product selection near the corresponding product object and uses layout rules that avoid overlapping text blocks. The user can read concise recommendations such as “This fresh red apple from region A at 150 yen matches your usual preference and provides stable quality.” The user may then issue a product selection input, for example by performing a gesture recognized by a sensor of the wearable display device or by touching the terminal screen. The terminal transmits a structured selection event, including the product identification information and the input type, to the server.

The server executes integrated processing of product selection, price payment, and delivery arrangement. The server contacts external transaction processing services and logistics management services using application programming interfaces. However, the server may again use the generative AI model to determine an optimized sequence of interactions, such as whether to aggregate multiple product orders into a single payment or whether to split deliveries among several carriers based on predicted delivery times. The server constructs prompt sentences that encode the set of selected products, available payment options, and carrier options, and requests the generative AI model to propose a sequence of operations subject to constraints such as minimizing the number of external calls or limiting timeouts.

The server then converts the proposed sequence into concrete API calls. By doing so, the server adaptively optimizes external transaction coordination, reducing the number of failed calls and improving the robustness of the overall system.

The server and the terminal implement specific data structures and processing sequences that differ from a mere automation of manual shopping tasks. The server uses encoded product identifiers, compressed attribute records, and vector representations of user preferences. The terminal uses multi-dimensional arrays of pixel data, bounding box lists, and anchor objects for augmented-reality rendering. The generative AI processing is not merely a high-level “assistant” but is integrated at the level of query planning and overlay layout selection. As a result, the system changes how the computer stores, accesses, and renders data, leading to measurable improvements in computational efficiency, such as lower average database query time, lower network traffic per shopping session, higher frame rate in AR rendering, and lower energy consumption on the terminal.

The server can implement alternative embodiments of the behavior model. In one embodiment, the server uses a sequence model such as a recurrent neural network or a transformer-based encoder to process a time-ordered sequence of user interactions. The server encodes each interaction as a vector and processes the sequence to obtain a context vector representing recent user behavior. This context vector is fed into the prompt construction process, enabling the generative AI model to generate different prompt sentences when the user has recently shifted interest from one category to another. Because the context vector is computed algorithmically using matrix multiplications and non-linear transformations, the system captures temporal patterns that are difficult to emulate by manual rule sets. This leads to improved prediction accuracy of future consumption behavior and reduces the number of irrelevant recommendations shown to the user.

In another embodiment, the terminal performs more of the recognition processing locally to further reduce network load. The terminal maintains a small product dictionary with a subset of product identification information and associated feature vectors that correspond to frequently purchased items at a particular facility. When the terminal recognizes a product object whose feature vector closely matches a local dictionary entry, the terminal can directly determine the product identification information without consulting the server. In such a case, the terminal only requests detailed product attribute information if local cache data are stale or incomplete. This hybrid approach between on-device recognition and server-based resolution reduces round-trip times and network usage.

In yet another embodiment, the server and terminal implement error handling and confidence-based decision logic based on numerical thresholds and confidence scores computed by the neural networks. For example, if the recognition confidence for a product object falls below a predetermined threshold, the terminal may present a generic overlay or request additional confirmation from the user. The server may also adjust the generative AI prompt to request an explanation text that emphasizes uncertainty, such as “This appears to be a medium-sized fruit, but identification is uncertain; please confirm before purchase.” By encoding uncertainty into both internal control signals and external outputs, the system reduces the risk of incorrect product selection and thereby reduces error rates compared with systems that lack integrated confidence handling.

The user operates the system in an environment such as a retail facility. The user wears the wearable display device connected to the terminal, and the user naturally looks at products.

The terminal and server together perform continuous recognition, data retrieval, model inference, prompt construction, and generative processing. The system thereby provides real-time, context-aware, and behavior-adaptive overlays. Because the server optimizes internal computer operations, such as query sequences and rendering priorities, using outputs from the generative AI model, the system improves computational performance beyond what could be achieved by static rule-based approaches. This constitutes an improvement in computer technology itself, including improved data management, increased processing speed, lower communication overhead, and higher quality of real-time augmented-reality rendering for shopping assistance.

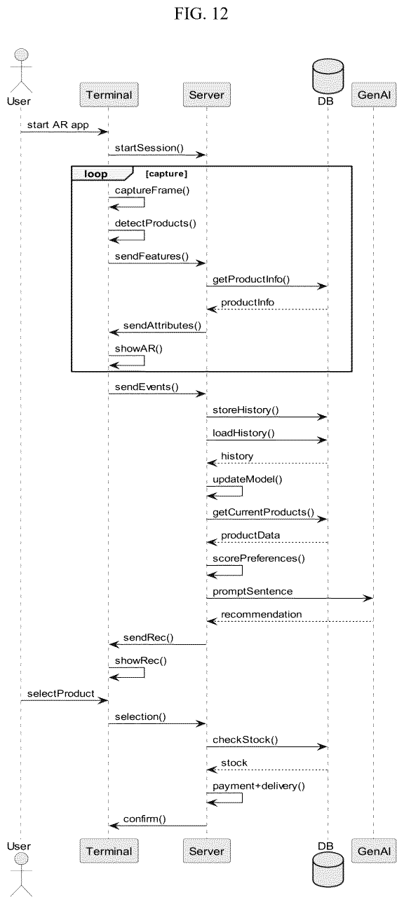

The following describes the processing flow using FIG. 12.

### Step 1:

The user wears the wearable display device and activates the shopping application on the terminal.

The input is a user operation such as tapping an icon or issuing a voice command. The output is an initialized application state on the terminal.

The terminal initializes hardware modules including the wireless communication interface and the imaging device of the wearable display device, and it allocates memory buffers for image frames and augmented-reality overlays. The terminal also sends a session start message to the server including a user identifier, a device identifier, and a facility identifier so that the server can prepare corresponding data structures.

### Step 2:

The terminal acquires image data from the imaging device and preprocesses the image data for recognition.

The input is a raw image frame stream from the imaging device, typically in a device-specific color format and resolution. The output is a normalized image tensor suitable for neural network input.

The terminal converts the raw pixel data into a standardized color space, resizes the image to a predetermined width and height, normalizes pixel intensities, and arranges the pixels in a multi-dimensional array. The terminal stores this array in memory and passes a pointer to the recognition module.

### Step 3:

The terminal detects product objects in the preprocessed image using an image processing program.

The input is the normalized image tensor generated in Step 2. The output is a list of detected product objects, each with a bounding box and a class probability.

The terminal executes a convolutional neural network-based detector that computes feature maps by convolving learned filters over the image tensor, applies non-linear activation functions, and generates candidate bounding boxes and class scores. The terminal selects bounding boxes with scores above a threshold and performs non-maximum suppression to remove overlapping boxes, thereby refining the list of product objects.

### Step 4:

The terminal generates feature vectors and local product identification candidates for each detected product object.

The input is the list of bounding boxes and the original image tensor. The output is, for each product object, a feature vector and, optionally, a local candidate identifier.

The terminal crops image patches corresponding to each bounding box, resizes them to a standard patch size, and feeds them into a feature extraction network. The feature extraction network computes intermediate activations layer by layer and outputs a fixed-length feature vector. In some embodiments, the terminal compares this feature vector with locally stored reference vectors using a similarity metric and, if a close match is found, assigns a candidate product identification information. The terminal packages the feature vectors, bounding box coordinates, and any local candidate identifiers into a message.

### Step 5:

The terminal transmits recognition results to the server for product identification resolution.

The input is the message containing feature vectors, bounding boxes, and optional local candidates. The output is a server-bound request including structured recognition data.

The terminal serializes the recognition data into a compact representation, compresses it if necessary, and sends it via a secure communication protocol to the server. The terminal includes metadata such as a timestamp and facility identifier so that the server can correlate the recognition results with the current session.

### Step 6:

The server resolves product identification information based on the received feature vectors.

The input is the recognition request from the terminal containing feature vectors and metadata. The output is a list of product identification information and associated confidence scores.

The server retrieves stored reference feature vectors from an information storage device and performs a similarity search between the received feature vectors and the stored vectors. The server computes a distance metric such as cosine distance for each candidate and selects the closest matches. The server assigns product identifiers to the received feature vectors and calculates confidence scores based on the distance values. The server prepares a mapping from bounding boxes to product identifiers and sends this mapping back to the terminal.

### Step 7:

The server acquires detailed product attribute information from an information storage device.

The input is the list of product identification information resolved in Step 6. The output is a set of product attribute records.

The server constructs database queries or structured requests that specify the requested product identifiers and attribute fields, such as price, freshness, origin, size, weight, and color. The server executes these queries against one or more information storage devices, retrieves the corresponding records, and populates data structures where each record contains the requested attribute values. The server may encode certain fields to reduce size and then serialize the records into a response message.

### Step 8:

The server transmits product attribute information to the terminal.

The input is the set of product attribute records generated in Step 7. The output is a response message containing structured product attribute information.

The server arranges the attribute records into a format indexed by product identification information and includes any additional metadata such as facility identifier and stock availability. The server serializes the data, applies compression if needed, and sends the response over the communication network to the terminal.

### Step 9:

The terminal associates product attribute information with recognized product objects and prepares augmented-reality overlays.

The input is the attribute information received from the server and the bounding boxes and product identifiers known locally from Step 3 and Step 6. The output is a set of overlay descriptors specifying content and screen position.

The terminal maps each product identifier to its corresponding bounding box in the current frame, calculates screen coordinates for overlay placement using the imaging device pose and camera projection parameters, and formats text elements representing price, freshness, origin, size, weight, and color. The terminal creates overlay descriptors that combine text content, visual style parameters, and positional data.

### Step 10:

The terminal renders the product attribute overlays on the display surface of the wearable display device.

The input is the set of overlay descriptors generated in Step 9. The output is a rendered frame containing the camera image and superimposed product attribute information.

The terminal invokes its graphics engine to draw the camera image as a background layer, then draws text boxes and icons at the specified positions on top of the background. The terminal uses font rendering routines and blending operations to integrate the overlays without obscuring critical parts of the image. The terminal sends the rendered frame or corresponding drawing commands to the wearable display device, causing the user to see the product attribute information superimposed on the real-world view.

### Step 11:

The server updates behavior history information and transaction history information based on user interactions.

The input is a stream of interaction events from the terminal, such as viewing events, selection events, and purchase confirmations. The output is updated history records stored in an information storage device.

The server parses each event to extract fields including user identifier, product identifier, event type, timestamp, and context parameters. The server appends behavior history records for viewing events and transaction history records for purchase events to the corresponding tables. The server may aggregate durations by accumulating successive viewing events for the same product.

### Step 12:

The server computes user preference features and updates a behavior model.

The input is the accumulated behavior history information and transaction history information for one or more users. The output is updated model parameters representing a behavior model.

The server forms numerical feature vectors that encode attributes of each interaction, including encoded product categories, normalized price values, freshness scores, time-of-day encodings, and facility encodings. The server feeds these feature vectors and corresponding labels, such as whether the user purchased or not, into a neural network training process. The server computes forward passes to generate predictions, calculates a loss value using an error function, and performs backpropagation to compute gradients. The server updates model weights using an optimization algorithm iteratively until convergence criteria are met. The resulting weights are stored as the current behavior model.

### Step 13:

The server evaluates the current viewed products using the behavior model to obtain preference scores.

The input is the product attribute information for products currently recognized in the user's field of view and the behavior model parameters from Step 12. The output is a set of preference scores for these products.

The server encodes the current product attributes into feature vectors compatible with the behavior model, including product category encodings and normalized attributes. The server performs inference by executing a forward pass through the trained neural network, computing output values that represent predicted likelihoods of user selection. The server normalizes these scores, for example by applying a softmax function over candidate products, and stores the resulting preference scores for later use in prompt construction.

### Step 14:

The server constructs a prompt sentence for a generative AI model based on product attributes and preference scores.

The input is the set of product attribute information and corresponding preference scores for the current context. The output is a textual prompt sentence that encodes these data in natural language.

The server fills a pre-defined template with dynamic values such as product price, freshness, origin, and the relative strength of user preference. The server may insert explicit instructions about output length, language, and style into the prompt sentence. The server concatenates literal text with formatted values to produce a continuous string, which functions as the prompt sentence for the generative AI model.

### Step 15:

The server generates recommendation text or control information by invoking the generative AI model with the prompt sentence.

The input is the prompt sentence generated in Step 14. The output is a generated text sequence that includes proposal content for product selection and, in some cases, internal control hints.

The server tokenizes the prompt sentence into model-specific tokens and passes the token sequence to the generative AI model. The generative AI model computes attention-based transformations and predicts successive output tokens until a stop condition is reached. The server decodes the output tokens into a character string. The server may parse the resulting text according to known markers or format rules to separate user-facing recommendation sentences from machine-oriented instructions such as query grouping suggestions.

### Step 16:

The server transmits generated natural language information and any control hints to the terminal.

The input is the generated text from the generative AI model and associated metadata such as product identifiers and confidence measures. The output is a server-to-terminal response message.

The server packages the recommendation text with identifiers that specify which product each recommendation relates to, and, when present, includes fields that describe display priorities or truncated lengths. If internal control information is present, the server stores it in the appropriate control module for query planning. The server then sends the recommendation data to the terminal via the communication network.

### Step 17:

The terminal overlays the recommendation text alongside product attribute information in the user's field of view.

The input is the recommendation text and associated product identifiers from Step 16, along with existing overlay descriptors. The output is an augmented set of overlay descriptors including both attribute data and proposal content.

The terminal associates each piece of recommendation text with the overlay corresponding to the same product identifier. The terminal formats the text according to constraints on font size and number of lines, and places the recommendation in a region adjacent to the existing attribute text. The terminal updates the rendering pipeline so that, in the next display refresh, the user perceives both factual attributes and concise recommendations superimposed on the camera image.

### Step 18:

The user issues a product selection input based on the displayed overlays.

The input is the visual presentation of product attributes and recommendations. The output is a selection event detected by the terminal.

The user performs an action such as gazing at a product for a defined dwell time, using a gesture recognized by sensors of the wearable display device, or tapping a control on the terminal. The terminal interprets this action as selection of a particular product identified by a product identifier and generates a selection event message that encapsulates the user identifier, product identifier, and selected quantity if applicable.

### Step 19:

The server processes the selection event to perform integrated product selection, payment, and delivery arrangement.

The input is the selection event from the terminal. The output is a set of transaction confirmations and delivery instructions.

The server validates the availability of the selected product by querying the information storage device, determines pricing conditions, and interacts with external payment services to charge the user's account. The server then communicates with external logistics services to schedule delivery, providing the product identifier, quantity, and destination information. The server aggregates response codes and confirmation numbers, stores them in the transaction history, and generates a confirmation message to be sent back to the terminal for presentation to the user.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional recommendation systems that run on general-purpose computer platforms typically rely on fixed heuristic rules or stand-alone predictive models to determine items to be recommended to users. In such systems, the recommendation logic is usually hard-coded or limited to a single statistical or machine learning model. As a result, these systems suffer from several technical limitations in terms of computer technology itself.

First, conventional systems often process transaction history information and browsing history information in an ad hoc manner without a unified feature generation pipeline optimized for time-series behavioral patterns. This leads to inefficient use of computing resources, redundant data access operations, and suboptimal memory layouts, which in turn degrade throughput and latency when the system must respond in near real time to user interactions.

Second, although machine learning models are sometimes employed, the generation of human-readable recommendation messages is frequently implemented as a simple template-based text mechanism separated from the predictive model. This separation prevents the system from exploiting the full predictive context when generating messages, and forces developers to manually maintain large sets of templates. From a computer-technical perspective, this results in duplicated processing paths, fragmented codebases, and increased complexity in orchestrating multiple subsystems.

Third, generative artificial intelligence models have recently been introduced to generate natural language messages, but in many implementations they are used only as generic text generators that are not tightly integrated with structured behavioral feature data and predictive outputs. In such architectures, the generative model is invoked with loosely defined input text, which leads to unstable outputs, increased need for post-processing, and unnecessary compute cycles due to inefficient prompt design and model invocation strategies.

Fourth, database retrieval operations for item-related information are typically executed using static query definitions that do not adapt to the observed distribution, update frequency, and usage state of user behavior data. This causes unnecessary data transfers, suboptimal query plans, and increased load on storage subsystems. The computer system therefore experiences performance bottlenecks in I/O throughput and query response time when serving a large number of concurrent users.

Fifth, conventional architectures do not coordinate the outputs of a predictive learning model and a generative artificial intelligence model in a systematic way. The predictive model may estimate future user behavior, and the generative model may create text independently, but there is no integrated mechanism to combine prediction results with generative outputs using machine-interpretable prompt sentences. This lack of coordination leads to redundant computations, inconsistent recommendation content, and difficulties in scaling the system while maintaining predictable behavior.

Accordingly, there is a need for a computer-implemented system and method that (i) constructs behavioral feature data from transaction history information and browsing history information in a structured, time-series-aware manner, (ii) tightly integrates a learning model and a generative artificial intelligence model through machine-generated prompt sentences, and (iii) dynamically optimizes database retrieval and recommendation generation based on learned consumption behavior patterns. Such a system should improve the efficiency of data processing pipelines, enhance the stability and relevance of generated messages, and reduce computational and I/O overhead, thereby improving the operation of the underlying computer technology itself.

The specific processing by the specific processing unit 290 of the data processing device 12 in Example 2 is realized by the following means.

The present invention provides a server comprising a processor and a storage device, the processor being configured to acquire transaction history information and browsing history information of a user and store the transaction history information and the browsing history information in the storage device; to perform preprocessing, including missing-value completion, normalization, encoding, and time-series alignment, on the stored transaction history information and the stored browsing history information to generate behavioral feature data; to input the behavioral feature data into a learning model based on a machine learning algorithm to learn a consumption behavior pattern of the user and to generate a prediction result for future transaction behavior of the user; to select, on the basis of the prediction result and item-related information stored in an item information database, a candidate item set to be presented to the user and generate recommendation information including the candidate item set; to generate a prompt sentence for a generative artificial intelligence model, the prompt sentence including the recommendation information and a summary of the consumption behavior pattern of the user; to input the generated prompt sentence into the generative artificial intelligence model and acquire, from the generative artificial intelligence model, a natural-language item selection proposal message corresponding to the candidate item set; and to transmit the item selection proposal message, as notification information, to a user terminal via a communication network. This enables a computer-implemented recommendation architecture in which behavioral feature generation, predictive modeling, database retrieval control, and natural-language message generation are tightly integrated, thereby improving processing efficiency, reducing redundant computations and data transfers, and enhancing the stability and relevance of recommendation outputs at the level of the underlying computer system.

The term “system” refers to an information processing arrangement including at least one processor, one or more storage devices, and one or more communication interfaces, configured to execute the functions described in the claims.

The term “processor” refers to a hardware computation unit, such as a central processing unit or a specialized processing circuit, configured to execute instructions to perform data acquisition, preprocessing, model inference, prompt generation, and communication control.

The term “storage” refers to a hardware memory resource, such as a volatile memory device or a non-volatile memory device, configured to store transaction history information, browsing history information, behavioral feature data, model parameters, and recommendation information.

The term “transaction history information” refers to data records representing past user transactions, including at least a user identifier, an item identifier, a transaction time, and one or more attributes related to the transaction.

The term “browsing history information” refers to data records representing past user interactions with presented items, including at least a user identifier, an item identifier, an access time, and one or more attributes related to viewing or accessing an item.

The term “preprocessing” refers to a series of data transformation operations applied to raw data, including at least missing-value completion, normalization, encoding, and time-series alignment, to generate data suitable for input to a learning model.

The term “missing-value completion” refers to a process of detecting absent or undefined data elements in the transaction history information or the browsing history information and replacing the absent or undefined data elements with substituted values according to predetermined rules.

The term “normalization” refers to a numerical transformation operation that scales or adjusts numerical attributes of the transaction history information or the browsing history information into a predetermined numerical range or distribution.

The term “encoding” refers to a conversion process that transforms categorical or symbolic attributes included in the transaction history information or the browsing history information into numerical representations suitable for processing by a learning model.

The term “time-series alignment” refers to a process of arranging or adjusting multiple data records along a temporal axis such that the records are ordered or aligned according to time-related information, thereby forming time-ordered behavioral sequences.

The term “behavioral feature data” refers to structured data generated by preprocessing the transaction history information and the browsing history information, the structured data including numerical and/or encoded representations of user behavior suitable for input to a learning model.

The term “learning model” refers to a computational model based on a machine learning algorithm, configured to receive behavioral feature data as input and to produce one or more prediction results, such as future transaction behavior predictions.

The term “machine learning algorithm” refers to a computational procedure that adjusts parameters of a model based on training data, including but not limited to neural network methods, regression methods, and classification methods.

The term “consumption behavior pattern” refers to a representation of regularities or tendencies in user behavior, including at least periodic purchase tendencies, preferred item categories, and price preferences, derived from behavioral feature data.

The term “prediction result” refers to output data generated by the learning model, the output data indicating at least a future purchase target, a future purchase timing, or a likelihood of a user performing a particular transaction.

The term “item-related information” refers to information associated with items available for recommendation, including at least item identifiers, item attributes, availability information, and pricing information.

The term “item information database” refers to a data storage structure configured to store and provide item-related information in response to retrieval requests.

The term “candidate item set” refers to a group of one or more items selected by the processor, on the basis of the prediction result and the item-related information, as potential items to be recommended to a user.

The term “recommendation information” refers to structured information generated by the processor, including at least the candidate item set and optionally additional attributes or scores associated with the candidate item set.

The term “prompt sentence” refers to a text sequence constructed by the processor, configured to be input to a generative artificial intelligence model, and including instructions and contextual information for controlling generation of natural-language output by the generative artificial intelligence model.

The term “generative artificial intelligence model” refers to a trained model configured to generate natural-language text based on an input prompt sentence, the model being capable of producing item selection proposal messages or optimization policies.

The term “item selection proposal message” refers to natural-language text generated by the generative artificial intelligence model, the text describing recommendations or suggestions relating to the candidate item set for presentation to a user.

The term “notification information” refers to data transmitted from the system to a user terminal, the data including at least an item selection proposal message and optionally identifiers or links to recommended items.

The term “user terminal” refers to an information processing device operated by or accessible to a user, such as a communication device or a computing device, configured to receive notification information and present at least part of the notification information to the user.

The term “communication network” refers to a wired or wireless network infrastructure that enables data communication between the system and the user terminal.

The term “distribution” refers to a statistical description of values or occurrences of transaction history information or browsing history information over a defined data set or time period.

The term “update frequency” refers to a measure indicating how often transaction history information or browsing history information is added, modified, or deleted within the system.

The term “usage state” refers to a condition or pattern of access and utilization of transaction history information or browsing history information, including at least access counts, access timing, and usage context.

The term “retrieval request” refers to a query or request issued by the processor to the item information database or another data storage to obtain item-related information.

The term “structure of a retrieval request” refers to an arrangement or composition of fields, predicates, and conditions included in the retrieval request.

The term “execution condition of a retrieval request” refers to one or more parameters or constraints controlling execution of the retrieval request, including at least filter conditions, sorting conditions, and resource usage limits.

The term “optimization policy” refers to one or more rules or guidelines obtained from the generative artificial intelligence model, indicating how to modify or control the structure and execution condition of a retrieval request for efficiency or relevance.

The term “prediction assistance information” refers to information generated by the generative artificial intelligence model in response to a prompt sentence instructing prediction, the information being used to supplement or adjust the prediction result of the learning model.

In one embodiment, a server, a terminal, and a communication network cooperate to implement a system that generates and delivers item selection proposal messages based on user behavior data and integrated predictive and generative processing.

The server includes at least one processor, a main memory, a non-volatile storage device, and a network interface. The server executes software components implemented, for example, in a programming language such as Python or another high-level language. The server uses a data processing library such as a table-based data handling library (e.g., a library similar to Pandas) and a numerical computation library (e.g., a library similar to NumPy) for data preprocessing. The server further uses a machine learning framework such as a neural network framework (e.g., a framework similar to TensorFlow or PyTorch) to implement a learning model and may access an external generative AI model via an application programming interface.

The server stores transaction history information and browsing history information in one or more databases. In a typical embodiment, the server uses a relational database management system (e.g., a system similar to PostgreSQL or MySQL) as an item information database and as a behavior log database. The server stores each transaction record as a row including fields such as a user identifier, an item identifier, a timestamp, a quantity, a price, and one or more categorical attributes such as category and brand. The server stores each browsing record as a row including a user identifier, an item identifier, an access timestamp, an action type (e.g., view, click, add-to-cart), and additional context attributes such as device type or session identifier.

The server preprocesses the stored transaction history information and browsing history information to generate behavioral feature data. The server loads data from the database into main memory as table structures. The server performs missing-value completion by scanning each column and replacing absent values with predetermined defaults, statistical aggregations, or learned values. For example, the server replaces a missing category field with a generic category value or an inferred category based on similar items.

The server performs normalization on numeric fields such as price, quantity, and time intervals. The server converts each numeric value x into a normalized value (x-μ)/σ, where μ is a mean value and σ is a standard deviation computed over a training set. This scaling improves numerical stability and accelerates convergence of gradient-based learning in the learning model. The server also applies min-max scaling in alternative embodiments, mapping values into a [0, 1] range.

The server performs encoding on categorical attributes. The server maps each category, brand, or item identifier to an integer index and, in some embodiments, creates one-hot vectors for low-cardinality attributes or uses embedding indices for high-cardinality attributes such as item identifiers. The server stores these encoded values in contiguous arrays in memory, improving cache locality and enabling vectorized operations.

The server performs time-series alignment by grouping records by user identifier and ordering them by timestamp. The server segments each user's sequence of events into fixed-length windows, such as sequences of the last N interactions. The server pads or truncates sequences as needed to maintain consistent input dimensions for the learning model. By aligning events in this manner, the server preserves temporal context and allows the learning model to detect periodic and sequential patterns.

Based on the above preprocessing operations, the server generates behavioral feature data consisting of multi-dimensional tensors. Each tensor includes, for each user, an ordered sequence of feature vectors representing individual events, and optionally global or user-level features such as average purchase frequency or preferred price range. The server stores this behavioral feature data in non-volatile storage as binary files (e.g., arrays or serialized objects) for efficient loading.

The server implements the learning model as a neural network configured to predict future transaction behavior. In one embodiment, the server constructs a recurrent neural network including an embedding layer, one or more recurrent layers (e.g., long short-term memory layers or gated recurrent units), and a fully connected output layer. The server configures the embedding layer to map integer item identifiers into low-dimensional continuous vectors.

The server configures the recurrent layers to process the time-ordered sequence of embeddings and to maintain hidden state vectors that capture temporal dependencies. The server configures the output layer to produce, for each time step or for an aggregated sequence, a probability distribution over candidate items or item categories.

The server trains the learning model using supervised learning. The server uses the behavioral feature data as input and uses subsequent items or categories as labels. The server defines a loss function, such as categorical cross-entropy, that measures a difference between the predicted probability distribution and the actual purchased or viewed item. The server computes gradients of the loss with respect to model parameters using backpropagation. The server updates model parameters using an optimization algorithm such as stochastic gradient descent or an adaptive method such as an Adam-type optimizer. The server repeats training over multiple epochs until validation metrics such as accuracy or recall reach a predetermined threshold or converge.

The server may employ data augmentation techniques specific to time-series behavior data.

For example, the server randomly masks some events, shifts sequences within a limited time window, or subsamples long sequences in order to improve robustness to missing logs and variations in user behavior. These operations cause the learning model to generalize better and to tolerate noise in real-world logs.

The server generates a prediction result for each user by running the trained learning model in inference mode. The server loads the latest behavioral feature data for a target user, passes it through the model, and obtains a probability vector indicating likely future purchase targets and potential purchase timing patterns (e.g., specific days of week or time-of-day windows).

Due to the structure of the model and the preprocessed features, this inference operation is performed with low latency and reduced memory overhead compared to naive, non-sequence-aware approaches.

The server selects a candidate item set on the basis of the prediction result and item-related information stored in the item information database. The server identifies items or categories with the highest predicted probabilities and executes optimized retrieval requests to the database. The server constructs a retrieval request by specifying filter conditions (e.g., category, price range, availability) and ordering conditions (e.g., predicted score, margin, stock). In some embodiments, the server controls the structure and execution condition of retrieval requests in accordance with an optimization policy generated as described below, thereby reducing unnecessary data transfer and database load.

The server generates recommendation information including the candidate item set and associated attributes such as predicted scores, category labels, and discount information. The server then generates a prompt sentence for a generative AI model. The prompt sentence includes both a summary of the user's consumption behavior pattern and details of the candidate item set. In one example, the server generates the following prompt sentence:

“Based on the user's purchase history, suggest the products that the user is most likely to buy next and generate a short notification. For example, if the user buys beer every Friday, recommend beer on Friday and write a friendly reminder within 40 words.”

In another example, the server generates a more structured prompt sentence:

“You are a recommendation message generator for an e-commerce app.

User behavior: buys beer almost every Friday evening and sometimes buys snacks together.

Recommended products:
Brand A Lager 6-pack, 10% off
Brand B IPA 6-pack, 5% off
Potato chips (large), regular price

Generate a concise notification encouraging the user to buy beer (and optionally snacks) today, in a friendly tone, under 50 words.”

In a further example, the server requests content in a different language:

“Using the following purchase history summary and recommended products, generate a short Japanese notification message. The user usually buys beer on Friday. Today is Friday.

Recommended products: Brand A Lager, Brand B IPA. The message should remind the user not to forget buying beer and mention at least one recommended brand.”

The server sends the generated prompt sentence to a generative AI model. The generative AI model may be executed on a separate computing system and accessed via a network interface, or may be deployed on the same server hardware. The generative AI model may be a transformer-based language model including multiple attention layers, feedforward layers, and positional encoding mechanisms. The model parameters are trained beforehand on large-scale text corpora and may be further fine-tuned using domain-specific recommendation texts.

The server receives a natural-language item selection proposal message generated by the generative AI model in response to the prompt sentence. The server may validate the message by enforcing length limits, language constraints, and content filters. Because the prompt sentence incorporates machine-readable structure (user pattern summary, ranked candidate items, and constraints), the generative AI model operates under more constrained conditions than generic text generation. This reduces the number of tokens generated, lowers computation time, and yields more stable outputs. Consequently, the system improves computational efficiency and reduces post-processing complexity compared to systems that rely on unstructured prompts.

In some embodiments, the server also generates a prompt sentence instructing optimization of the structure and execution condition of retrieval requests to the item information database.

The server uses statistical summaries of the distribution, update frequency, and usage state of transaction and browsing data as input conditions. The server obtains an optimization policy from the generative AI model describing, for example, index usage, filtering strategies, and query partitioning. The server then adjusts its database query generator in accordance with the optimization policy. This integration enables the server to dynamically adapt query plans to real-time usage, thereby reducing response times and lowering I/O load.

In other embodiments, the server generates a prompt sentence instructing prediction of future purchase targets and timing. The server includes, as input description, behavioral features such as periodic purchase tendencies, preferred categories, and price preferences that have been extracted by the learning model. The generative AI model produces prediction assistance information, such as textual explanations or probability estimates for specific time windows. The server combines this prediction assistance information with the numerical prediction result of the learning model to refine the candidate item set and to adjust the content of the item selection proposal message. This combined approach improves both the accuracy of item selection and the interpretability of recommendations.

The server transmits the item selection proposal message, as notification information, to the terminal via the communication network. The server may use a push messaging service, an email protocol, or an in-app messaging channel. The notification information includes at least the natural-language message and may further include item identifiers, deep links to item pages, and metadata for rendering.

The terminal is an information processing device such as a mobile communication device or a personal computing device. The terminal includes a processor, a memory, a display, and a network interface. The terminal receives notification information from the server over the communication network. The terminal parses the notification payload, displays the item selection proposal message on the display, and provides interactive elements such as buttons or links allowing the user to access corresponding item pages. The terminal may also send event logs back to the server when the user interacts with the message, thereby closing the feedback loop for further learning.

The user operates the terminal to perform actions such as viewing recommended items, adding items to a cart, and completing transactions. The user's actions cause additional transaction history information and browsing history information to be generated. The terminal transmits these logs to the server, and the server incorporates them into subsequent preprocessing and model updates. By continuously updating the learning model and adjusting prompt sentences according to evolving behavior, the system maintains high-quality recommendations over time.

The above architecture improves computer technology in several ways. Because the server generates behavioral feature data using structured, time-series-aware preprocessing, the learning model operates on compact, aligned tensors instead of raw logs. This reduces memory usage and computational redundancy. The server's use of normalized and encoded features enables faster convergence of the neural network during training and more stable inference. The combined use of a predictive learning model and a generative AI model through machine-generated prompt sentences allows the server to separate numerical prediction from natural-language generation while still tightly coordinating both processes.

This coordination reduces the need for large, manually maintained rule sets or templates, decreases code complexity, and improves scalability.

Moreover, the server's use of optimization policies produced by the generative AI model to control database retrieval requests is not a mere automation of human query design. Instead, the server systematically integrates statistical behavior metrics and machine-generated query optimization instructions into its query engine. This integration leads to reduced network traffic between application logic and storage, lower disk I/O, and improved throughput when handling simultaneous user requests. As a result, the overall system achieves measurable improvements in processing speed, resource utilization, and recommendation accuracy.

In addition, the server implements non-conventional processing steps that differ from simple human decision-making workflows. For example, the server simultaneously considers time-series embeddings, item similarity in a learned vector space, and generative constraints in prompt sentences, something that a human operator could not feasibly compute in real time for large user populations. The learning model uses gradient-based training with defined loss functions and optimization algorithms, and the generative AI model uses multi-layer attention mechanisms to condition text generation on complex structured inputs. These technical details and interactions demonstrate that the system is directed to specific improvements in computer data processing, model orchestration, and database query management rather than to abstract business concepts alone.

Various modifications and alternative embodiments are possible. In some embodiments, the server replaces the recurrent neural network with a transformer-based architecture using self-attention mechanisms over event sequences. In other embodiments, the server uses a convolutional neural network or a hybrid model that combines recurrent and attention layers.

The server may vary the size of the embedding vectors, the number of layers, and other hyperparameters to balance accuracy and computational cost. The server may adjust normalization methods, encoding strategies, and time-series segmentation rules depending on data characteristics. The server may also integrate additional behavior signals, such as dwell time on pages or interaction with search results, into the behavioral feature data.

In yet another embodiment, the terminal performs a subset of preprocessing, such as lightweight encoding of events before transmission, to reduce network usage. The server then performs heavier preprocessing, training, and inference. In still other embodiments, multiple servers distribute the workload by separating data ingestion, model training, and inference into distinct modules connected over a data center network.

Through these embodiments, the server, the terminal, and the communication network implement a concrete technical solution in which structured behavior modeling, prompt-based generative processing, and adaptive database control cooperate to achieve improved processing efficiency, higher prediction accuracy, reduced latency, and lower communication and storage loads.

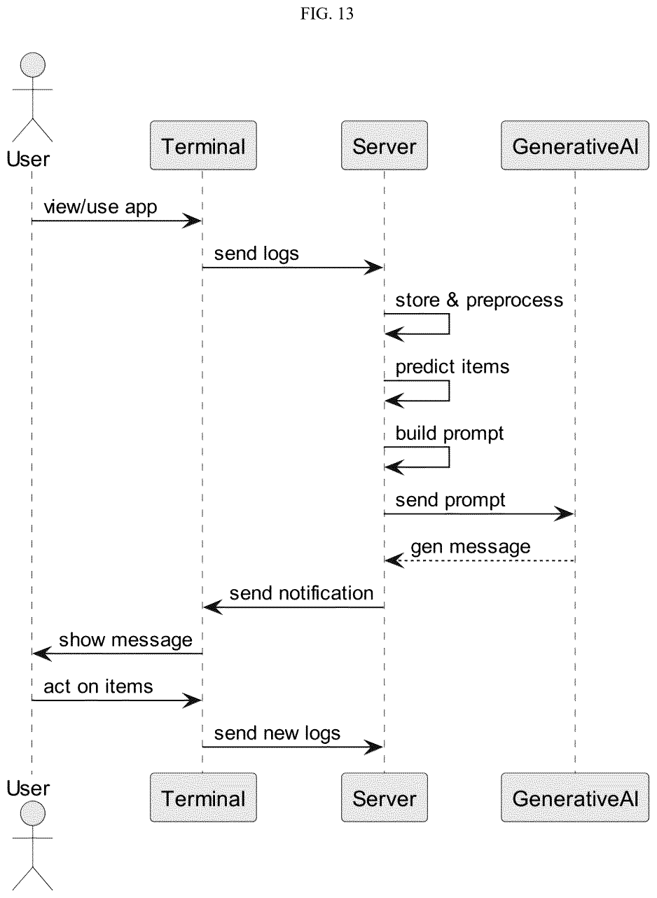

The following describes the processing flow using FIG. 13.

### Step 1:

The server acquires user behavior logs.

The server receives, as input, raw transaction history information and browsing history information generated when the user operates the terminal to view items, add items to a cart, or complete purchases. The server obtains these logs via an application programming interface over a communication network. The server parses the received data to extract fields such as user identifier, item identifier, timestamp, action type, quantity, and price, and the server stores each parsed record as a row in one or more database tables. As output, the server generates structured behavior log entries stored in a behavior log database.

### Step 2:

The server consolidates and filters behavior data.

The server reads, as input, the structured behavior log entries from the behavior log database for a selected user or user group. The server executes database queries to join transaction tables and browsing tables, to filter logs by a defined time window (for example, the last twelve months), and to exclude incomplete or corrupted records. Based on this input, the server performs data selection operations and removes duplicate entries using key fields such as user identifier, item identifier, and timestamp. As output, the server produces a consolidated behavior dataset containing cleaned and de-duplicated records for the target user.

### Step 3:

The server performs missing-value completion.

The server receives, as input, the consolidated behavior dataset including numeric fields and categorical fields that may contain missing values. The server scans each column to detect missing or null values, and the server computes replacement values such as mean or median for numeric attributes and most-frequent or default labels for categorical attributes. The server then replaces each missing value with a corresponding replacement value, thereby generating a dense dataset without gaps. As output, the server obtains a completed behavior dataset in which all required fields are populated.

### Step 4:

The server normalizes and encodes behavior attributes.

The server receives, as input, the completed behavior dataset including numeric attributes (such as price, quantity, time intervals) and categorical attributes (such as item category, brand, and action type). The server calculates statistical parameters such as mean and standard deviation for numeric attributes and applies a normalization operation (for example, z-score normalization) to generate normalized numeric values. The server then maps categorical attributes to integer indices and, when appropriate, converts them into one-hot vectors or embedding indices. Through these data transformations, the server converts heterogeneous input values into standardized numeric representations. As output, the server generates an encoded behavior dataset composed of normalized numeric fields and encoded categorical fields.

### Step 5:

The server constructs time-series behavioral feature data.

The server receives, as input, the encoded behavior dataset that includes user identifiers and timestamps for each record. The server groups records by user identifier and sorts them in ascending order of timestamp to form sequences of behavior events. The server segments each sequence into fixed-length windows or sessions, padding or truncating sequences as needed to achieve uniform length. For each event in a sequence, the server concatenates normalized numeric fields and encoded categorical fields into a feature vector. The server stacks these feature vectors into multi-dimensional arrays representing time-ordered behavior for each user. As output, the server generates behavioral feature data suitable for input to a learning model.

### Step 6:

The server trains the learning model using behavioral feature data.

The server receives, as input, the behavioral feature data and corresponding labels indicating actual future items or categories that the user purchased or viewed after each sequence window. The server initializes a neural network model, for example, a recurrent neural network or a transformer-based network configured with embedding layers, sequence-processing layers, and an output layer. The server repeatedly feeds batches of feature sequences and labels into the model, computes prediction outputs, and calculates a loss value such as categorical cross-entropy between the predictions and the labels. The server performs backpropagation to compute gradients of the loss with respect to model parameters and updates the parameters using an optimization algorithm. As output, the server produces a trained learning model whose weights encode consumption behavior patterns of users.

### Step 7:

The server generates prediction results for a target user.

The server receives, as input, the most recent behavioral feature data for a specific user, generated using the same preprocessing and sequence construction as during training. The server loads the trained learning model in inference mode and passes the user's feature sequence through the model to obtain a probability distribution over candidate items or item categories for a future transaction. The server may also compute derived indicators such as the most likely purchase day of the week or time-of-day based on temporal features. As output, the server generates a prediction result specifying one or more likely future purchase targets and associated confidence scores.

### Step 8:

The server retrieves item-related information and selects a candidate item set.

The server receives, as input, the prediction result and accesses an item information database containing item-related information such as item identifiers, attributes, stock status, and pricing. The server constructs and executes retrieval requests that filter items based on categories, price ranges, and availability consistent with the prediction result. The server ranks retrieved items according to the predicted probabilities and additional criteria such as recency, diversity, or inventory constraints. As output, the server selects a candidate item set comprising one or more items to be recommended to the user, together with associated metadata (for example, name, price, discount, and ranking score).

### Step 9:

The server generates recommendation information.

The server receives, as input, the candidate item set and the prediction result, including consumption behavior patterns such as periodic purchase tendencies and preferred categories.

The server formats these inputs into a structured internal representation that includes item identifiers, textual item descriptions, predicted scores, and a summary of the user's behavior (for example, “frequently purchases beverages on Fridays” or “prefers mid-range prices for cosmetics”). The server may compute additional features such as a diversity score for the candidate item set to avoid redundant recommendations. As output, the server produces recommendation information that encapsulates both the selected items and the underlying behavior pattern context.

### Step 10:

The server constructs a prompt sentence for a generative AI model.

The server receives, as input, the recommendation information for the target user. The server converts the behavior summary and candidate item descriptions into natural-language fragments and combines them with instructions describing the desired style, length, and language of the output message. For example, the server generates a prompt sentence such as:

“Based on the user's purchase history, suggest the products that the user is most likely to buy next and generate a short notification. For example, if the user buys beer every Friday, recommend beer on Friday and write a friendly reminder within 40 words.”

Or the server may generate a prompt sentence such as:

“You are a recommendation message generator for an e-commerce app.

User behavior: buys beer almost every Friday evening and sometimes buys snacks together.

Recommended products:
Brand A Lager 6-pack, 10% off
Brand B IPA 6-pack, 5% off
Potato chips (large), regular price

Generate a concise notification encouraging the user to buy beer (and optionally snacks) today, in a friendly tone, under 50 words.”

As output, the server produces a prompt sentence that encodes behavior context and item details for the generative AI model.

### Step 11:

The server invokes the generative AI model and obtains an item selection proposal message.

The server receives, as input, the constructed prompt sentence. The server sends the prompt sentence to a generative AI model implemented, for example, as a transformer-based language model accessible via an application programming interface. The server specifies generation parameters such as maximum token count and sampling temperature. The generative AI model processes the prompt sentence and returns generated natural-language text. The server validates the returned text by checking length constraints, language requirements, and prohibited terms. As output, the server acquires a natural-language item selection proposal message describing recommendations and encouraging the user to consider the candidate item set.

### Step 12:

The server prepares notification information for delivery.

The server receives, as input, the item selection proposal message and the candidate item set.

The server constructs a notification payload including the natural-language message, item identifiers, and deep links to item detail pages. The server may add metadata such as expiration time, notification category, and personalization tags. The server encodes the payload as a structured message suitable for a push notification service or an email service.

As output, the server generates notification information ready to be transmitted over the communication network.

### Step 13:

The server transmits the notification information to the terminal.

The server receives, as input, the prepared notification information and a destination identifier corresponding to the terminal. The server sends the notification payload via a push messaging service, an email server, or an in-app messaging channel, using the network interface. The server may log the transmission event in a delivery log table for monitoring and analysis. As output, the server delivers the notification information to the terminal, making the item selection proposal message available to the user.

### Step 14:

The terminal receives and presents the item selection proposal message.

The terminal receives, as input, the notification information sent by the server through the communication network. The terminal decodes the payload, extracts the natural-language item selection proposal message and associated item identifiers, and displays the message on a user interface, such as a notification panel or an application screen. The terminal may render interactive controls that allow the user to open detailed item pages or to dismiss the notification. As output, the terminal presents the content to the user and generates interaction events when the user responds.

### Step 15:

The user interacts with recommended items, and the terminal sends new behavior logs.

The user receives, as input, the displayed item selection proposal message and optionally taps links or buttons to view detailed item information or perform transactions. The terminal captures these user actions as new browsing or transaction events and packages them into log records. The terminal transmits these new log records back to the server via the communication network. As output, the terminal and the user jointly generate updated behavior logs, which become new input data for the server in subsequent executions of Steps 1 through 11, enabling continuous refinement of predictions and recommendations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented recommendation systems typically generate suggestions based on static rules or simple statistical correlations applied to product data and user purchase history. In such systems, a server generally retrieves item records from a data repository, applies fixed scoring logic, and returns a ranked list to a client device. This approach presents several technical problems.

First, existing architectures do not manage the interaction between large-scale behavioral data, real-time emotional state information, and a generative AI model in a unified control loop on the server side. As a result, the server cannot flexibly adapt its internal data structures, prompts to the generative model, or retrieval strategies in response to evolving user behavior and context. This leads to inefficient use of computation and storage resources, because the same coarse-grained models and queries are applied regardless of current session signals or emotional state.

Second, conventional systems generally treat recommendation generation and backend data retrieval as separate pipelines. Databases are queried using static or hand-tuned query templates, without using higher-level semantic instructions or prompt sentences generated by a generative AI model. This separation prevents dynamic optimization of query conditions and search order based on the generative model's understanding of user intent, which in turn increases response time, causes unnecessary database access, and fails to scale efficiently when the number of items and facilities increases.

Third, many systems do not maintain a closed feedback loop in which user interaction signals and emotion signals are continuously integrated into both the predictive behavior model and the prompt construction logic for the generative AI model. In these systems, even if user feedback is logged, it is usually processed in batch offline and is not used to adapt prompt content or data selection strategies on a per-session basis. This results in technically sub-optimal use of compute resources, because the generative AI model is repeatedly invoked with prompt sentences that are not tailored to the current user state, and leads to redundant output that must be heavily post-filtered on the server.

Fourth, conventional server-client recommendation architectures often implement cross-entity payment and delivery flows in isolated modules that do not share state with the recommendation logic. Thus, the server cannot optimally coordinate recommendation generation with constraints such as inventory, pricing, or delivery capabilities across multiple transaction entities, and must perform additional, separate calls and checks after recommendations are generated. This causes additional network traffic, duplicate data processing, and increased latency.

Accordingly, there is a need for a computer-centric technique that improves how a server system (i) acquires and structures transaction object data, user behavior history, and emotional state information, (ii) constructs and supplies prompt sentences and structured input to a generative AI model, (iii) interprets and filters the model's output using system-level constraints, and (iv) closes the loop by updating a behavior prediction model and prompt-construction logic, all in a way that reduces redundant computation, reduces unnecessary database access, and provides more efficient and adaptive operation of the overall information processing architecture.

The specific processing by the specific processing unit 290 of the data processing device 12 in Application Example 2 is realized by the following means.

The present invention provides a server comprising a processor configured to access an information storage unit storing an information set regarding transaction facilities and acquire attribute information regarding transaction objects from the information set, to generate input data to be supplied to a generative information processing model based on the attribute information, behavior history information of a user, and emotional state information of the user, the input data including a prompt sentence that semantically specifies proposal content for the transaction objects, to transmit the input data including the prompt sentence to the generative information processing model and acquire output data including the proposal content from the generative information processing model, to analyze the output data to extract identification information and explanation information associated with the transaction objects and determine a proposal target set by narrowing down the transaction objects based on inventory status information, price condition information, and rejection history information of the user, to acquire attribute information corresponding to the proposal target set from the information storage unit, convert the attribute information together with the explanation information into display information, and transmit the display information to a user terminal, to acquire selection operation information and purchase operation information from the user terminal, store the selection operation information and the purchase operation information as the behavior history information in the information storage unit, transmit processing requests to at least one external processing apparatus to execute payment processing and delivery processing across a plurality of transaction entities, and update a behavior prediction model using machine learning based on the behavior history information and the emotional state information and dynamically change components of the prompt sentence and a configuration method of the input data in accordance with an update result of the behavior prediction model. This enables the server to implement an integrated, closed-loop information processing pipeline in which database retrieval, generative AI invocation, output interpretation, and behavior model updating are mutually coordinated, thereby reducing redundant database access, improving the efficiency and specificity of prompt sentences supplied to the generative AI model, adapting recommendation computation to real-time user behavior and emotion, and optimizing backend transaction processing within a single, technically improved computer system.

The term “system” refers to a combination of at least one hardware apparatus and at least one software component that cooperatively execute information processing operations as described in the claims.

The term “processor” refers to a hardware processing unit, such as a central processing unit or other execution circuitry, configured to execute instructions to perform the functions described in the claims.

The term “information storage unit” refers to any memory or storage resource, including a database, file system, or non-transitory storage medium, that stores structured or unstructured digital data used by the processor.

The term “information set” refers to a logically organized collection of records or data elements stored in the information storage unit, including but not limited to records regarding facilities, items, users, or transactions.

The term “transaction facility” refers to any physical or virtual entity that provides items or services for exchange, including but not limited to retail locations, commercial entities, or service providers.

The term “transaction object” refers to an item, service, or other subject of exchange that can be proposed to a user and can be the target of a purchase or other transaction.

The term “attribute information” refers to data describing properties or characteristics of a transaction object, including but not limited to category, price, quality, origin, size, weight, and availability.

The term “user” refers to an individual or entity that interacts with the system via a user terminal and is a target of proposals or transactions generated by the system.

The term “behavior history information” refers to data representing past actions of the user in relation to the system, including but not limited to browsing events, selection operations, purchase operations, and feedback signals.

The term “emotional state information” refers to data indicating an estimated or inferred emotional condition of the user, obtained from analysis of text, audio, visual input, or other signals associated with the user.

The term “generative information processing model” refers to a trained computational model, such as a generative artificial intelligence model, that produces new textual or structured output data in response to input data including a prompt sentence.

The term “prompt sentence” refers to a textual input or instruction supplied to the generative information processing model that specifies a desired output behavior or content, including conditions for proposal generation or data interpretation.

The term “input data” refers to digital data supplied to the generative information processing model, including at least one prompt sentence and optionally structured or semi-structured contextual information.

The term “output data” refers to digital data produced by the generative information processing model in response to the input data, including proposed items, explanations, or other generated content.

The term “proposal content” refers to information indicating which transaction objects should be recommended to the user and optionally including reasons, conditions, or ranking associated with such recommendations.

The term “identification information” refers to data that uniquely or distinctly identifies a transaction object, such as an internal identifier, code, or other distinguishing reference.

The term “explanation information” refers to data that describes a rationale, reason, or context for including a transaction object in proposal content, including but not limited to textual explanations and justification attributes.

The term “proposal target set” refers to a subset of transaction objects selected by the processor from among available objects, which are determined to be appropriate for presentation to the user as recommendations.

The term “inventory status information” refers to data indicating whether and to what extent a transaction object is currently available for supply, including stock levels, availability flags, or allocation states.

The term “price condition information” refers to data specifying pricing-related parameters for a transaction object, including base price, discount, promotion status, or user-specific pricing constraints.

The term “rejection history information” refers to data representing user actions that indicate negative interest in or refusal of transaction objects, including explicit rejections, skips, or low ratings.

The term “display information” refers to data formatted or prepared for presentation on a user interface of a user terminal, including layout, text, images, and other visual or interactive elements.

The term “user terminal” refers to an electronic device used by the user to interact with the system, such as a mobile device, computing device, wearable device, or other client apparatus.

The term “selection operation information” refers to data indicating that the user has selected, highlighted, or otherwise chosen at least one transaction object from among presented options.

The term “purchase operation information” refers to data indicating that the user has initiated or confirmed a transaction to acquire at least one transaction object, including quantity and payment intent.

The term “external processing apparatus” refers to a computing resource or service distinct from the processor of the system, used to perform processing related to payment, delivery, or other auxiliary operations.

The term “payment processing” refers to operations for authorizing, settling, or otherwise handling financial transactions associated with purchases of transaction objects.

The term “delivery processing” refers to operations for organizing, scheduling, and managing physical or electronic delivery of transaction objects to a destination associated with the user.

The term “transaction entity” refers to a party involved in providing, selling, or delivering a transaction object, including but not limited to vendors, intermediaries, or logistics providers.

The term “behavior prediction model” refers to a trained computational model configured to infer or estimate future behavior of the user based on past behavior history information and optionally other contextual information.

The term “machine learning” refers to a class of computational techniques in which a model is trained using data to automatically improve its performance on a given task without being explicitly programmed with task-specific rules.

The term “update result of the behavior prediction model” refers to information indicating changed parameters, structure, or performance metrics of the behavior prediction model after at least one training or adaptation operation.

The term “query optimization information” refers to data specifying conditions, ordering, or strategies for executing a search or query on the information set in a manner that improves performance or efficiency.

The term “query conditions” refers to criteria included in a search or query for limiting or filtering records within the information set, such as attribute ranges or matching constraints.

The term “query order” refers to an arrangement or sequence in which multiple queries or subqueries are to be executed against the information set.

The term “search commands” refers to instructions or queries directed to the information storage unit or database engine to retrieve, filter, or aggregate data from the information set.

The term “learning data” refers to data supplied to the behavior prediction model for training, retraining, or fine-tuning, including preprocessed behavior history information and emotional state information.

The term “time information” refers to data indicating temporal aspects associated with user behavior or system events, including timestamps, time intervals, or time-zone identifiers.

The term “classification information of the transaction objects” refers to data indicating categories, types, or groupings of transaction objects used to structure behavior analysis or model training.

The term “future transaction behavior” refers to predicted actions or patterns of a user related to selection, purchase, or interaction with transaction objects that have not yet occurred at the time of prediction.

The term “time zone” refers to a temporal segment or period used to group or differentiate behavior, such as a time of day, day of week, or other temporal interval relevant to system operation.

In one embodiment, a server, a terminal, and a user cooperate to implement the system defined in the claims. The server includes at least one processor, a main memory, a non-transitory storage device, and a network interface. The server executes an operating system and middleware including a relational database management system, a web application framework, and machine learning libraries. The terminal includes a processor, a display unit, an input unit, a communication unit, and optionally a camera and a microphone.

The user operates the terminal to receive proposals of transaction objects and to perform selection and purchase operations.

The server stores an information storage unit in the non-transitory storage device. The server implements the information storage unit as one or more databases managed by a database management system such as a relational database engine. The server defines tables or collections for at least a facility table, an item table, a user table, a behavior history table, an emotion table, an order table, and a configuration table. The server associates each item record with attribute information such as category identifier, facility identifier, base price, discount value, origin code, size parameters, weight parameters, available stock quantity, and other attributes. The server assigns a unique identification information value to each item record and to each facility record.

The server accesses the information storage unit via structured queries. The server constructs queries as structured query language statements or equivalent commands. The server generates query optimization information, including query conditions and query order, based on internal heuristics and output from a generative AI model. The server composes search commands that perform index-based selection, join operations between tables, and aggregation operations. The server uses indexes on item identifiers, facility identifiers, category codes, and time fields in order to reduce search time and decrease disk I/O.

The terminal establishes a communication session with the server via a network and sends requests for product listings, recommendation results, and transaction processing. The terminal transmits user identification information, session identifiers, and device information to the server using secure communication protocols. The terminal receives display information from the server and renders it on the display unit using a graphical user interface framework. The terminal displays lists of items, explanation information, and input widgets for selection and purchase operations. The terminal records user inputs such as taps, scrolls, and text entries and sends corresponding operation information to the server.

The user operates the terminal to browse item proposals and to perform selection and purchase operations. The user may enter textual feedback, search keywords, or short reviews.

The user may speak into the microphone or allow the camera to capture facial expressions.

The user thus provides both explicit and implicit signals that the server uses as behavior history information and emotional state information.

The server acquires behavior history information by receiving logs of user interactions from the terminal. The server writes each event into the behavior history table with fields including user identifier, item identifier, event type, timestamp, facility identifier, and session identifier.

The server normalizes these events by transforming them into fixed-length feature vectors.

The server encodes categorical values such as item category and facility type as embeddings or one-hot vectors. The server aggregates events into time windows such as hourly or daily slots and computes derived features such as frequency of category views, recency of purchases, and ratio of accepted proposals to rejected proposals.

The server acquires emotional state information from multiple channels. The server receives user-entered text such as reviews or comments and processes the text with a natural language processing library such as a tokenizer and a part-of-speech tagger. The server applies a sentiment classification model implemented as a neural network to output an emotion label such as joy, satisfaction, anger, or disappointment, together with a confidence score. The server receives audio signals from the terminal and converts the audio to text using a speech-to-text component. The server optionally extracts acoustic features such as pitch and energy and applies a speech emotion classifier implemented as a recurrent neural network or transformer model. The server receives images or video frames from the terminal camera and applies a convolutional neural network to estimate facial expressions. The server fuses results from text, audio, and video analysis using a fusion layer that computes a weighted combination of modality-specific scores. The server writes the fused emotion label and associated scores into the emotion table together with user identifier and timestamp.

The server uses a behavior prediction model to estimate future transaction behavior of the user. The server implements the behavior prediction model as a machine learning model, for example a neural network combining an embedding layer, a sequence model, and a dense output layer. The server feeds sequences of past user events into the sequence model, which may be a long short-term memory network, a gated recurrent unit network, or a transformer encoder. The server defines a loss function such as cross-entropy loss over next-item predictions or a ranking loss over candidate items. The server trains the behavior prediction model by iteratively updating weights using gradient descent with backpropagation. The server supplies batches of training data consisting of feature sequences and target labels, computes gradients of the loss function, and updates model weights. The server periodically retrains or fine-tunes the model using newly accumulated behavior history information and emotional state information.

The server uses the behavior prediction model output as structured context for a generative AI model. The server interprets the predicted probabilities or ranking scores as signals of user interest across item categories, facilities, and time slots. The server converts these signals into compact feature summaries, for example top-ranked categories, estimated purchase time windows, and sensitivity to discounts. The server stores these summaries in memory for prompt construction.

The server uses a generative AI model to generate prompt sentences and proposal content.

The server implements the generative AI model as a large language model or similar generative information processing model with a transformer architecture. The server loads a pre-trained model that contains multiple layers of self-attention and feed-forward sublayers.

The server executes the generative AI model on a computing resource such as a graphics processing unit or a specialized accelerator. The server supplies input data to the generative AI model in the form of a tokenized prompt sentence and optional appended structured context. The server configures model parameters such as maximum output length, sampling temperature, top-k or top-p constraints, and output formatting instructions.

The server constructs the prompt sentence by combining attribute information, behavior history information, emotional state information, and predicted future behavior. The server maps these internal data structures into human-readable statements that instruct the generative AI model to perform a specific task. Example prompt sentences include:

“Based on the user's past purchase history, propose the products that the user is most likely to buy next. Use the attached structured data of recent purchases and browsing events.” “Using the user's past purchase history and preferences, recommend suitable products from multiple retail facilities. Prioritize items that match the user's favorite brands and typical purchase times.”

“When the user shows a joyful emotion, suggest products that fit this positive mood. Consider the user's previous purchase history and currently popular seasonal items, and list several products that the user is likely to enjoy.”

“Extract the emotion from the following user review text and adjust the product recommendations accordingly. If the emotion is positive, strengthen recommendations for similar products; if it is negative, avoid similar products. Then output an updated product recommendation list.”

“When the user searches for ‘smartphone case,’ explain how to retrieve product information from multiple sales platforms, compare prices and reviews, and present a concise list of the best options. Generate a short explanation and a ranked list format.”

“The user usually buys beer on Fridays and is currently expressing a joyful emotion. Using this pattern and today's date (Friday morning), generate a notification message recommending this week's beer specials from nearby stores.”

“Using the user's purchase history and emotion data, determine which product should be suggested next. The current emotion is joy; please select items aligned with this emotion and with the user's past preferences.”

“When the user smiles while looking at a product in the store, propose related products that match the user's joyful emotion. Use product details obtained via the store's API and the user's past favorite categories to generate specific product suggestions.”

The server may also generate prompt sentences that instruct the generative AI model to produce query optimization information. For example, the server may use a prompt sentence such as:

“Given the user's current interest in discounted items and limited stock, generate an efficient order of database queries and filter conditions to retrieve high-availability, low-price items in the user's preferred categories.”

By constructing such prompt sentences, the server leverages the generative AI model not only for natural language recommendations, but also for internal system optimization tasks, thereby improving query planning and data retrieval efficiency.

The server analyzes the output data produced by the generative AI model. The server parses the generated text using pattern matching, tokenization, and simple parsing rules. The server extracts identification information such as item codes, category names, or facility references from the generated text. The server extracts explanation information such as reasons for recommendation, mood alignment phrases, or timing-related suggestions. The server maps the extracted identifiers back to actual records in the information storage unit. The server discards or corrects entries that do not correspond to valid items or that violate system constraints.

The server determines a proposal target set by applying filtering and ranking to the list of candidate items. The server consults inventory status information to exclude items that are out of stock or below a threshold quantity. The server consults price condition information to enforce user-specific limits or promotional rules. The server checks rejection history information to remove items that the user has previously refused or negatively rated. The server combines the ranking from the behavior prediction model, the relevance implied by the generative AI output, and system constraints into a final score for each item. The server selects items whose final score exceeds a threshold or that occupy top positions in the ranking as the proposal target set.

The server constructs display information for the terminal. The server retrieves attribute information of each item in the proposal target set and attaches explanation information derived from the generative AI output. The server formats this data into a structured representation including fields for item name, price, thumbnail image path, short explanation, and call-to-action labels. The server transforms this structure into a representation suitable for terminal display, such as a markup or serialized object. The server transmits the display information to the terminal via the network interface.

The terminal receives the display information and renders it as user interface components.

The terminal may display sections such as “Recommended for you,” “Because you seemed happy today,” or “Friday beer specials.” The terminal associates each displayed item with identifiers so that subsequent user selections can be transmitted back to the server.

The user reviews the displayed proposals and performs operations such as selecting items or confirming purchases. The terminal captures these operations and transmits selection operation information and purchase operation information to the server. The server records these operations as new behavior history information and updates user profiles accordingly.

The server uses this updated behavior history to refine future predictions and proposals.

The server performs payment processing and delivery processing by communicating with external processing apparatus. The server assembles order data including selected items, facility identifiers, user delivery address, and payment details. The server transmits payment requests to an external payment processing apparatus via an application programming interface. The server receives authorization or rejection responses and updates the order table.

The server transmits delivery requests to an external logistics apparatus that handles shipment. The server receives tracking information from the external apparatus and records it in the order table.

The server updates the behavior prediction model using the newly collected behavior history information and emotional state information. The server schedules training jobs that read data from the behavior history table and emotion table, construct training batches, and perform parameter updates for the model. The server adjusts hyperparameters such as learning rate, batch size, and regularization coefficients to stabilize learning. The server evaluates the updated model on a validation subset, monitors performance metrics such as hit rate, recall, or mean reciprocal rank, and accepts the updated model only if it meets quality thresholds.

The server then uses the updated model to generate new behavior-based context for subsequent prompt sentences.

The server dynamically changes components of the prompt sentence and configuration of input data in accordance with the update result of the behavior prediction model. For example, when the model identifies that a user has shifted interest from one category to another, the server modifies future prompt sentences to emphasize the new category. When the model detects that emotion signals strongly correlate with purchase decisions in specific time zones, the server adds explicit references to time windows and emotional state into the prompt sentences. By adjusting the prompts and input structure, the server reduces the amount of irrelevant content generated by the generative AI model and decreases the need for extensive post-filtering, thereby reducing processor load and improving response time.

The server thereby improves computer technology in several concrete ways. The server integrates a behavior prediction model and a generative AI model in a closed-loop architecture, where model updates directly influence prompt construction and query optimization. This integration reduces redundant queries to the information storage unit by narrowing search scopes based on model predictions before executing queries. The server uses emotion fusion and behavior modeling to rank and pre-filter candidates before invoking the generative AI model, which reduces the size of input data and the number of tokens processed by the generative AI model. This reduction leads to lower computation time on accelerators and decreases network traffic between the server and any external generative model service. The server uses generative AI not only for user-facing text generation but also for producing query optimization information, which leads to improved caching, better index usage, and overall lower latency in data retrieval.

The server implements non-conventional data structures and processing flows compared to simple rule-based recommenders. The server stores unified event sequences with both behavior and emotion attributes, trains sequence models that jointly encode these attributes, and uses their outputs as context for generative prompts. This approach departs from human manual recommendation or static rules by exploiting high-dimensional feature spaces and non-linear mappings learned from data. The server also uses rule-based post-processing specifically tailored to correct and constrain the generative AI output according to system state, which is different from simply accepting generated text as-is.

Alternative embodiments are possible. In another embodiment, the server hosts the generative AI model entirely on-premise, while in another embodiment, the server accesses a remote generative AI service over a network. In some embodiments, the behavior prediction model may use a factorization machine or gradient boosting model instead of a neural network. In yet another embodiment, the emotion recognition pipeline may omit video analysis and rely only on text and audio. In one embodiment, the terminal is a wearable display device with integrated camera and microphone, while in another embodiment, the terminal is a desktop computer. In all such variations, the server continues to acquire attribute information, construct prompt sentences based on behavior and emotion, invoke the generative AI model, filter and interpret the output, update a prediction model, and dynamically adjust prompt construction and data configuration in accordance with updated model results, thereby achieving the technical effects described above.

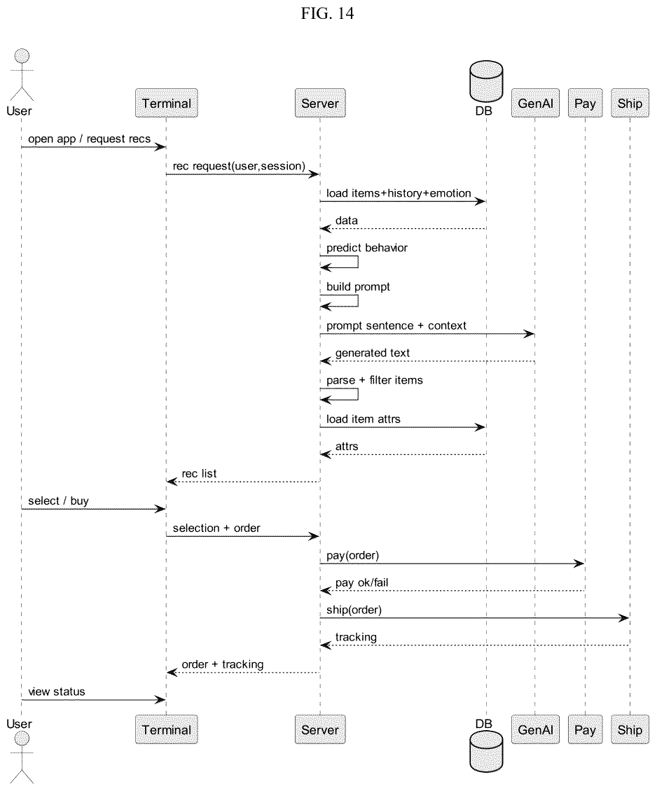

The following describes the processing flow using FIG. 14.

### Step 1:

Server initializes data structures and connections.

Server sets up connections to an information storage unit, a behavior history database, an emotion database, and external processing apparatus.

Input: configuration data (database connection strings, API endpoints, model paths).

Output: live connections and initialized in-memory caches (for facilities, items, and user profiles).

Server loads schema definitions for facility, item, user, behavior, emotion, and order tables, and creates in-memory indexes (for example, hash maps keyed by item ID and user ID) to accelerate later lookups.

### Step 2:

Server acquires transaction facility and transaction object attributes.

Server issues structured queries to the information storage unit to retrieve attribute information such as category, price, origin, size, weight, and stock quantity for each transaction object.

Input: facility identifiers, query conditions (for example, active items, date ranges).

Output: a normalized item list stored in memory and optionally cached on disk.

Server executes joins between facility and item tables, converts raw rows into structured objects, and applies unit conversions and normalization (for example, converting all weights to a common unit).

### Step 3:

Terminal initiates a user session.

Terminal authenticates the user, acquires a user identifier (from login or token), and starts logging interactions.

Input: user credentials or authentication token, device information.

Output: a session identifier, stored locally on the terminal and registered on the server.

Terminal transmits the session identifier and user identifier to the server so that subsequent operations can be associated with the correct user.

### Step 4:

User begins interaction through the terminal.

User navigates the interface, requests item lists or recommendations, and optionally provides initial search keywords.

Input: graphical elements and text fields presented on the display.

Output: interaction events such as button presses, search queries, and view requests sent to the server.

Terminal packages each user action into an event message containing event type, timestamp, and current screen context.

### Step 5:

Terminal sends a recommendation request.

Terminal generates a request containing user ID, session ID, current view (for example, home screen, category page), and optional search terms, and sends it to the server over a secure channel.

Input: user identifier, session identifier, current screen context, search keyword (optional).

Output: a structured recommendation request message transmitted to the server.

Terminal encodes this message in a structured format and sets headers for authentication and versioning.

### Step 6:

Server retrieves behavior history for the user.

Server queries the behavior history database to obtain recent events such as views, selections, and purchases.

Input: user identifier, time window (for example, last 90 days).

Output: a chronologically ordered sequence of behavior events for the user.

Server converts raw log entries into a sequence of feature vectors by encoding categorical attributes (item ID, category, facility) and numeric attributes (time intervals, prices).

### Step 7:

Server retrieves emotional state history for the user.

Server reads records from the emotion database associated with the user and the current session or recent sessions.

Input: user identifier, session identifier, time window.

Output: a set of emotion labels, confidence scores, and timestamps.

Server aggregates these records into summary statistics (for example, dominant emotion per day or per session) and constructs an emotion profile vector.

### Step 8:

Server computes current behavior features.

Server synthesizes the retrieved behavior and emotion data into a unified feature structure suitable for the behavior prediction model.

Input: behavior event sequence, emotion profile vector.

Output: an input tensor or equivalent structure for the behavior prediction model.

Server sorts events by timestamp, truncates or pads sequences to a fixed length, and attaches emotion features to corresponding time steps to form joint feature vectors.

### Step 9:

Server invokes the behavior prediction model.

Server feeds the feature structure into the trained behavior prediction model and runs forward inference.

Input: sequence tensor containing encoded behavior and emotion features.

Output: predicted probabilities or scores for candidate transaction objects or categories.

Server obtains output vectors representing likelihood of future purchases and converts these into sorted lists of candidate categories and items.

### Step 10:

Server selects candidate transaction objects for prompting.

Server uses the prediction scores to narrow the universe of items to a manageable candidate set before involving the generative AI model.

Input: predicted scores for transaction objects or categories, item attribute cache.

Output: a candidate item set with associated scores.

Server filters out items not matching basic constraints (for example, unavailable facilities, expired items) and retains top-ranked candidates based on the prediction scores.

### Step 11:

Server constructs structured context for prompt building.

Server converts the candidate item set, user behavior summary, and emotion profile into compact structured descriptions.

Input: candidate item set, behavior summary (top categories, recency patterns), emotion profile.

Output: a structured context object for prompt construction.

Server computes derived signals, such as “frequent Friday beer purchases” or “preference for discounted items,” and stores them in the context object.

### Step 12:

Server generates a prompt sentence for the generative AI model.

Server composes a natural language instruction that describes the task and embeds key parts of the structured context.

Input: structured context (behavior, emotion, attributes), system configuration for the current scenario.

Output: a prompt sentence string.

Server concatenates template fragments with dynamically computed clauses, such as:

“The user usually buys beer on Fridays and is currently expressing a joyful emotion. Using this pattern and today's date (Friday morning), generate a notification message recommending this week's beer specials from nearby stores.”

### Step 13:

Server prepares input data for the generative AI model.

Server combines the prompt sentence with a serialized representation of relevant structured context (for example, top candidate items and summary statistics).

Input: prompt sentence, structured context object.

Output: a generative model input object containing tokens and optional metadata.

Server tokenizes the prompt sentence, appends any directives about output format, and attaches context as additional text or structured annotations, depending on the model interface.

### Step 14:

Server calls the generative AI model.

Server sends the prepared input to the generative AI model and waits for the generated output.

Input: generative model input object (tokens plus context).

Output: a generated output sequence, typically text containing item suggestions and explanations.

Server specifies parameters such as maximum token length, temperature, and sampling method to control generation behavior.

### Step 15:

Server parses the generated output.

Server analyzes the generated text to extract candidate identifiers, category names, and explanation phrases.

Input: generated text output from the generative AI model.

Output: a parsed structure containing candidate references and explanation strings.

Server applies pattern matching and tokenization, detects item references (for example, item codes or recognizable names), and associates each proposed item with the explanation segment that follows or precedes it.

### Step 16:

Server validates and maps generated references to actual items.

Server matches each referenced item in the parsed structure against records in the information storage unit.

Input: parsed references (names, codes, categories), item database.

Output: a list of valid item identifiers aligned with explanations.

Server performs exact and fuzzy matching against item names and codes, discards non-resolvable references, and corrects minor mismatches where clear candidates exist.

### Step 17:

Server filters candidates using system constraints.

Server applies inventory, price, and rejection history constraints to the validated candidate items.

Input: validated item identifiers, inventory status data, price condition data, rejection history data.

Output: a filtered proposal target set with associated explanations and scores.

Server executes constraint checks to remove items that are out of stock, beyond user-specified price limits, or present in the user's rejection history, and re-ranks remaining items by combining prediction scores and model-inferred relevance.

### Step 18:

Server constructs display information for the proposal target set.

Server retrieves full attribute information for each item in the proposal target set and packages it with an explanation string for display.

Input: proposal target set (item IDs plus explanations), item attribute records.

Output: a display information payload for the terminal.

Server formats this data into structures containing item name, price, thumbnail URL, facility name, and the explanation text generated or refined from the generative output.

### Step 19:

Terminal receives and renders the proposal target set.

Terminal receives the display information and presents it as a list or grid of recommended items.

Input: display information payload from the server.

Output: visual UI components showing proposed items and explanations.

Terminal creates interactive widgets for each item, such as “View details” and “Add to cart” buttons, and registers event handlers for user actions.

### Step 20:

User reviews and selects items.

User scans through the recommended items, taps certain items to view details, and chooses some items for purchase.

Input: displayed recommendation list and item detail screens.

Output: user interaction events such as selection actions and cart modification actions.

User may also provide feedback such as “hide this product” or rating values, which the terminal records as explicit preference signals.

### Step 21:

Terminal sends selection and purchase operation information.

Terminal collects the list of selected items, quantities, and any explicit feedback, and sends this data to the server.

Input: user selection events, cart contents, explicit feedback markers.

Output: selection operation information and purchase operation information messages.

Terminal includes session and user identifiers to allow correlation with behavior history.

### Step 22:

Server records behavior history and updates logs.

Server writes the received selection and purchase information into the behavior history database.

Input: selection operation information, purchase operation information.

Output: new behavior history entries stored in the database.

Server updates per-user aggregates such as total purchases by category and most recently purchased items to accelerate future predictions.

### Step 23:

Server initiates payment processing.

Server constructs a payment request containing order details and user payment data and sends it to an external processing apparatus responsible for payment.

Input: cart contents, user payment method token, order total.

Output: a payment authorization response and a payment status record.

Server checks the response code, logs transaction identifiers, and sets the order status to “authorized” or “failed” accordingly.

### Step 24:

Server initiates delivery processing.

Server contacts an external logistics apparatus with shipment details and delivery address.

Input: order items, delivery address, preferred delivery options.

Output: a delivery order record and tracking number.

Server stores the tracking number in the order table and updates the order status to “shipped” when confirmation is received.

### Step 25:

Server sends order confirmation and tracking information to the terminal.

Server generates a summary of the order, including item list, total amount, payment status, and tracking data, and sends it to the terminal.

Input: order record, payment status, tracking information.

Output: an order confirmation payload.

Server also schedules notification messages for subsequent status changes (for example, “out for delivery,” “delivered”).

### Step 26:

Terminal displays order confirmation and delivery status.

Terminal presents the order summary and provides an interface for the user to track shipment.

Input: order confirmation payload, later status update notifications.

Output: visual confirmation screens and updated tracking displays.

Terminal periodically refreshes or receives push updates and visually reflects status transitions for the user.

### Step 27:

Server schedules model update using new behavior and emotion data.

Server identifies newly stored behavior and emotion records and schedules them for training or fine-tuning of the behavior prediction model.

Input: incremental behavior history records, recent emotion records.

Output: a training batch plan and updated training datasets.

Server constructs input-target pairs (for example, past sequences and next-item labels) and assigns them to the training pipeline.

### Step 28:

Server updates the behavior prediction model.

Server runs a training process that adjusts model parameters based on the new data.

Input: training batches containing feature sequences and target outcomes.

Output: updated model parameters and performance metrics.

Server computes a loss function (such as cross-entropy) over predictions, calculates gradients, and updates weights; then the server evaluates performance and, if improved, promotes the new model version for inference.

### Step 29:

Server updates prompt construction rules based on model performance.

Server analyzes which features and patterns most strongly contributed to improved predictions and adjusts prompt templates accordingly.

Input: updated model parameters, feature importance data, performance metrics.

Output: revised prompt sentence templates and context selection rules.

Server, for example, increases emphasis on features (like time-of-day buying patterns) that yielded more accurate predictions, causing future prompt sentences to explicitly mention these aspects.

### Step 30:

Server reduces data load for future generative AI calls.

Server applies new rules to further pre-filter candidate items and compress context before creating prompt sentences.

Input: revised prompt templates, updated pre-filtering rules, item corpus.

Output: smaller, more targeted input data for the generative AI model.

Server limits the number of items included in context, focuses on the most predictive features, and thereby decreases token count and computation time in subsequent generative calls.

### Step 31:

Server and terminal continue the closed-loop operation.

Server and terminal repeatedly execute the above steps across sessions, continually refining predictions, prompts, and system parameters.

Input: ongoing user interactions, new behavior and emotion data, updated model results.

Output: increasingly personalized and efficient recommendations and backend processing.

Server leverages each completed cycle to further optimize internal data flows, model configurations, and prompt sentences, resulting in improved processing speed, reduced unnecessary database access, and higher accuracy of proposed transaction objects.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

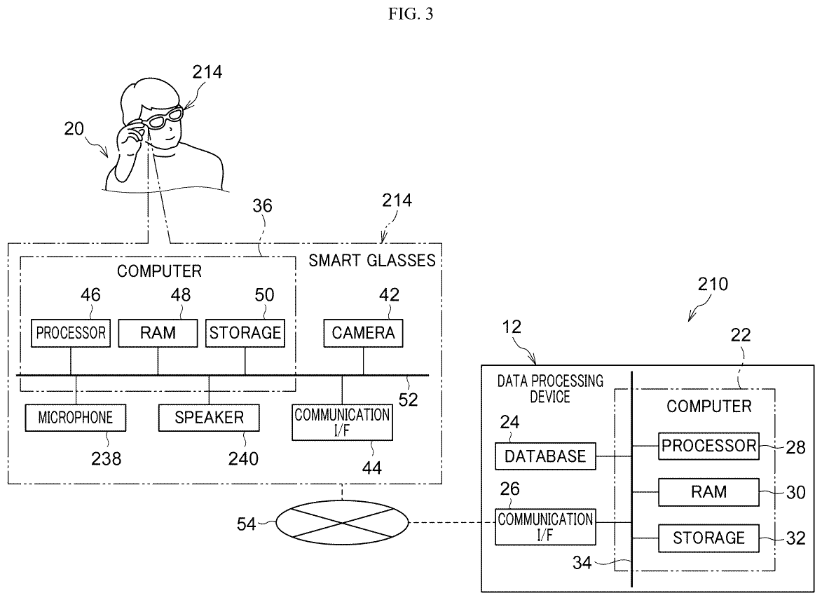

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

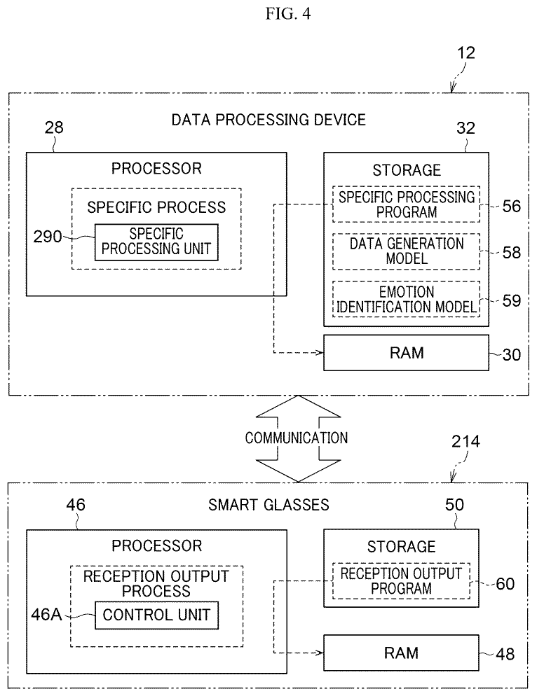

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

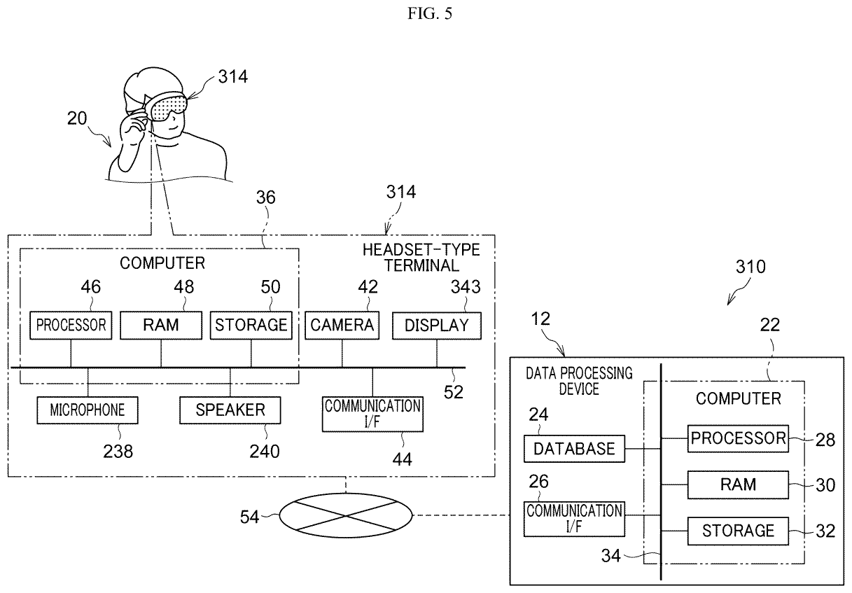

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

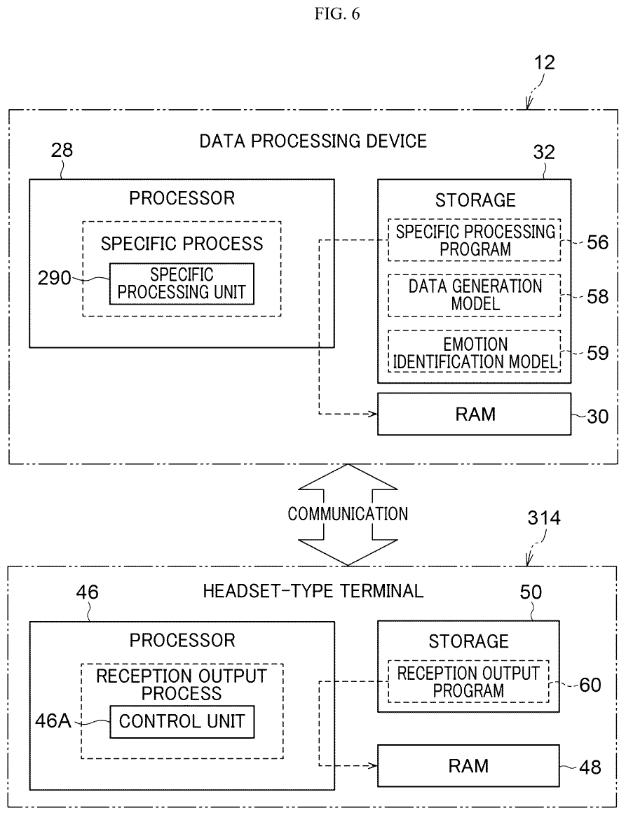

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12.

For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

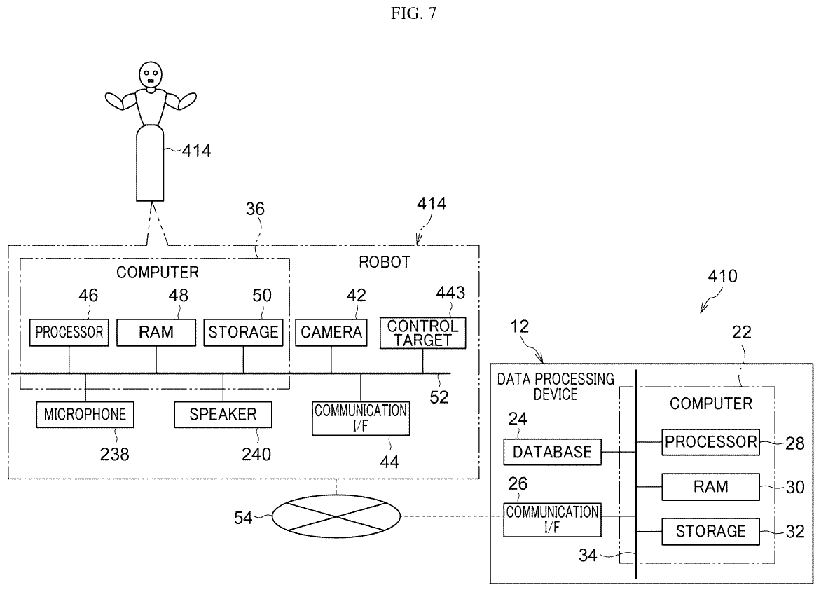

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

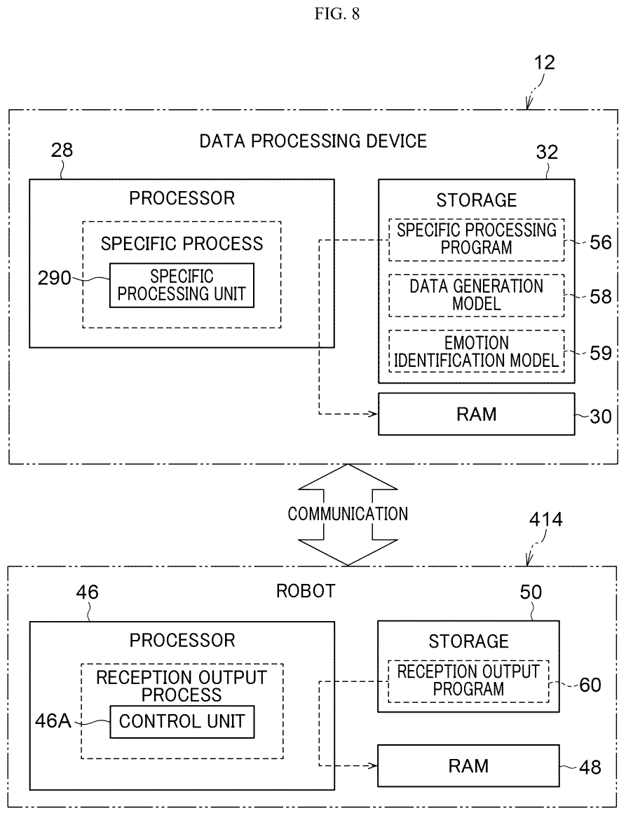

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

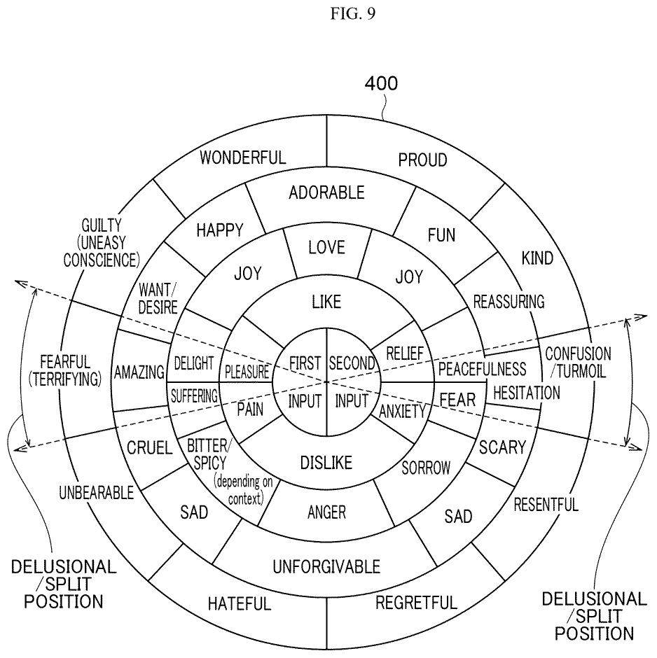

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

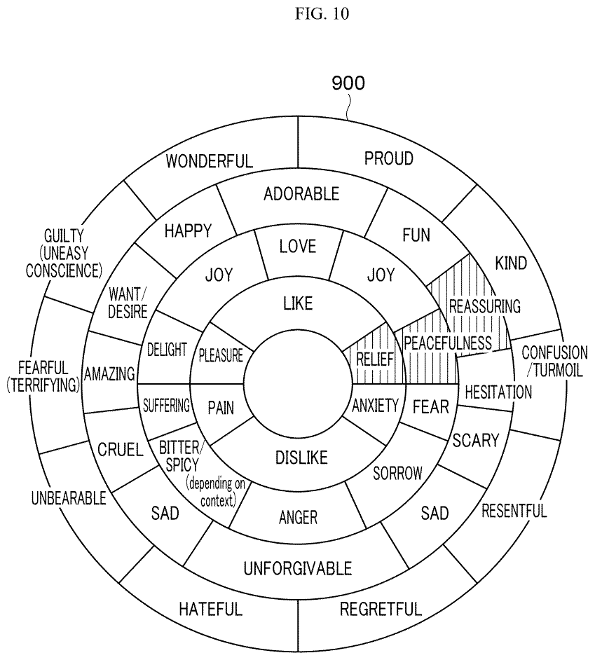

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor and a communication terminal having a display device, wherein the processor is configured to
access an information providing mechanism of a commercial transaction site and acquire a set of sales target information,
store the acquired set of sales target information in a structured information storage mechanism and execute aggregation processing and evaluation processing based on price attributes, quality attributes, origin attributes, dimension attributes, mass attributes, and
appearance attributes of the sales targets,
extract the sales targets based on selection conditions of a user and behavior history information of the user and calculate, for the extracted sales targets, a unit-quantity price, a ranking index, and a preference suitability degree,
generate a composite prompt sentence including context information comprising the extraction result and the calculated results and an instruction sentence in natural language for input to a generative information processing model, and transmit the composite prompt sentence to the generative information processing model to cause the generative information processing model to generate an explanation sentence or a proposal sentence relating to product selection,
generate response information by associating the explanation sentence or the proposal sentence obtained from the generative information processing model with the extraction result, and transmit the response information to the communication terminal, and
wherein the communication terminal is configured to visually represent, on the display device, the set of sales target information included in the response information and present the explanation sentence or the proposal sentence in association with the visually represented set of sales target information to the user.

### (Supplementary 2)

The system according to supplementary 1,
wherein the processor is configured to
generate a prompt sentence indicating query optimization conditions based on a load and a response time of a query to the structured information storage mechanism and the selection conditions of the user, and control a query expression used to extract the sales targets in accordance with the query optimization conditions.

### (Supplementary 3)

The system according to supplementary 1,
wherein the processor is configured to
analyze purchase history information and browsing history information of the user to estimate preference feature values and behavior tendencies, and incorporate profile information including the preference feature values and the behavior tendencies into a prompt sentence for input to the generative information processing model in order to instruct the generative information processing model to perform prediction of consumer behavior and to provide a proposal for product selection.

### Application Example 1

### (Supplementary 1)

A system comprising a processor,
wherein the processor is configured to
access, via a communication network, an information storage device provided in a plurality of commercial facilities, and acquire product attribute information based on product identification information,
acquire an image captured by an imaging device mounted on a wearable display device, recognize a product object included in the image by using an image processing program, and generate the product identification information based on a result of the recognition, control display of the wearable display device so as to visually present the product attribute information in a state of being superimposed on the image on a display surface of the wearable display device,
accumulate behavior history information and transaction history information of a user, and generate a behavior model representing a consumption behavior characteristic of the user on the basis of the behavior history information and the transaction history information, generate a prompt sentence to be input to a generative information processing model on the basis of the product attribute information and the behavior model, input the prompt sentence to the generative information processing model, and generate natural language information including proposal content for product selection,
control display of the wearable display device so as to present the natural language information, together with the product attribute information, in a state of being superimposed on the image on the display surface of the wearable display device to support selection of a product within a current field of view of the user, and
execute, in response to a product selection input from the user, integrated processing of product selection, price payment, and delivery arrangement with respect to the plurality of commercial facilities.

### (Supplementary 2)

The system according to supplementary 1,
wherein the processor is configured to
generate, on the basis of the product identification information and the product attribute information, a prompt sentence for optimizing execution of an inquiry process to the information storage device, input the prompt sentence to the generative information processing model, and generate control information including a control condition or an execution procedure of the inquiry process.

### (Supplementary 3)

The system according to supplementary 1,
wherein the processor is configured to
generate, on the basis of the behavior history information and the transaction history information, a prompt sentence for predicting future consumption behavior of the user, input the prompt sentence to the generative information processing model, and generate natural language information including a prediction result and proposal content for product selection based on the prediction result.

### Example 2

### (Supplementary 1)

A system comprising a processor,
wherein the processor is configured to
acquire transaction history information and browsing history information of a user, and store the transaction history information and the browsing history information in a storage, perform preprocessing, including missing-value completion, normalization, encoding, and time-series alignment, on the stored transaction history information and the stored browsing history information to generate behavioral feature data,
input the behavioral feature data into a learning model based on a machine learning algorithm to learn a consumption behavior pattern of the user and to generate a prediction result for future transaction behavior of the user,
select, on the basis of the prediction result and item-related information stored in an item information database, a candidate item set to be presented to the user, and generate recommendation information including the candidate item set,
generate a prompt sentence for a generative artificial intelligence model, the prompt sentence including the recommendation information and a summary of the consumption behavior pattern of the user,
input the generated prompt sentence into the generative artificial intelligence model and acquire, from the generative artificial intelligence model, a natural-language item selection proposal message corresponding to the candidate item set, and
transmit the item selection proposal message, as notification information, to a user terminal via a communication network.

### (Supplementary 2)

The system according to supplementary 1,
wherein the processor is configured to
generate, on the basis of a distribution, an update frequency, and a usage state of the transaction history information and the browsing history information of the user, a prompt sentence to be input to the generative artificial intelligence model, the prompt sentence instructing optimization of a structure and an execution condition of a retrieval request for acquiring the item-related information, and control a retrieval process for the item information database according to an optimization policy obtained as a response from the generative artificial intelligence model.

### (Supplementary 3)

The system according to supplementary 1,
wherein the processor is configured to
generate a prompt sentence instructing prediction of a future purchase target and a future purchase timing, the prompt sentence using, as input conditions, the consumption behavior pattern including a periodic purchase tendency, a preferred category, and a price preference of the user extracted on the basis of the behavioral feature data, input the prompt sentence into the generative artificial intelligence model to obtain prediction assistance information, and adjust selection of the candidate item set and content of the item selection proposal message by combining the prediction assistance information with the prediction result generated by the learning model.

### Application Example 2

### (Supplementary 1)

A system comprising a processor,
wherein the processor is configured to
access an information storage unit storing an information set regarding transaction facilities and acquire attribute information regarding transaction objects from the information set, generate input data to be supplied to a generative information processing model, the input data being configured based on the attribute information regarding the transaction objects, behavior history information of a user, and emotional state information of the user so as to cause the generative information processing model to generate a prompt sentence describing proposal content for the transaction objects to the user, transmit the input data including the prompt sentence to the generative information processing model, and acquire output data including the proposal content from the generative information processing model,
analyze the output data acquired from the generative information processing model to extract identification information and explanation information associated with the transaction objects, and determine a proposal target set to be presented to the user by narrowing down the transaction objects based on inventory status information, price condition information, and rejection history information of the user,
acquire the attribute information from the information storage unit based on the identification information of the transaction objects included in the proposal target set, convert the attribute information together with the explanation information into display information, and transmit the display information to a user terminal to present the proposal target set to the user, acquire selection operation information and purchase operation information regarding the proposal target set from the user terminal, store the selection operation information and the purchase operation information as the behavior history information in the information storage unit, and transmit processing requests to an external processing apparatus to execute payment processing and delivery processing across a plurality of transaction entities, and
update a behavior prediction model using machine learning based on the behavior history information and the emotional state information, and dynamically change components of the prompt sentence and a configuration method of the input data in accordance with an update result of the behavior prediction model.

### (Supplementary 2)

The system according to supplementary 1,
wherein the processor is configured to
generate query optimization information including query conditions and a query order, by using a prompt sentence that instructs output of the generative information processing model when acquiring the attribute information from the information set regarding the transaction facilities, construct a sequence of search commands for the information set based on the query optimization information, and optimize a search process for the information set.

### (Supplementary 3)

The system according to supplementary 1,
wherein the processor is configured to
supply the behavior history information and the emotional state information as learning data subjected to preprocessing in association with time information and classification information of the transaction objects to the behavior prediction model, and incorporate a prediction result of future transaction behavior by the behavior prediction model into the prompt sentence as a part of input to the generative information processing model, thereby changing the proposal content to the user in accordance with a time zone and the emotional state.

What is claimed is:

1. A system comprising:
circuitry configured to:
receive, via a communication interface coupled to a packet-switched network, selection parameters and interaction history data from a terminal device, and generate a structured condition incorporating the selection parameters stored in a storage device;
tokenize a prompt sentence incorporating the structured condition and interaction history data, configure inference parameters including temperature and maximum output length, transmit the tokenized prompt sentence to an inference engine executing a generative neural network model, and decode an output token sequence from the inference engine to obtain a ranked result set as a text string; and
parse the text string to extract record identifiers, attribute descriptions, and relevance scores, normalize the extracted record identifiers to canonical identifiers stored in the storage device, and transmit the parsed ranked result set to the terminal device via the communication interface.

2. The system according to claim 1, wherein the circuitry is configured to apply subword segmentation to the prompt sentence prior to tokenization, encode the segmented prompt sentence using a vocabulary index of the generative neural network model stored in the storage device, and configure the inference engine with a decoding strategy retrieved from the storage device.

3. The system according to claim 2, wherein the circuitry is configured to generate the prompt sentence by assembling a context section comprising the structured condition and a statistical summary of interaction history data, and an instruction section directing the generative neural network model to generate a ranked result set with relevance explanations.

4. The system according to claim 3, wherein the circuitry is configured to compute a multi-attribute weighted aggregate score for each record in the ranked result set by applying a scoring function that assigns numerical weights to attribute dimensions derived from the selection parameters, and combine the weighted aggregate score with a preference match score derived from the interaction history data.

5. The system according to claim 4, wherein the circuitry is configured to compute the preference match score as a cosine similarity between a preference feature vector derived from the interaction history data and an attribute feature vector computed from record attribute values stored in the storage device.

6. The system according to claim 5, wherein the circuitry is configured to filter records in the ranked result set having a combined score below a predetermined threshold, and retransmit the tokenized prompt sentence to the inference engine when a minimum number of qualifying records is not satisfied.

7. The system according to claim 1, wherein the circuitry is configured to analyze the interaction history data by extracting event records from the storage device, computing a frequency vector and a recency-weighted preference vector over record category codes, and deriving a preference feature vector as a weighted combination of the frequency vector and the recency-weighted preference vector.

8. The system according to claim 7, wherein the circuitry is configured to generate a prediction prompt sentence incorporating the preference feature vector and a temporal recency weighting applied to recent interaction events, transmit the prediction prompt sentence to the inference engine, and decode an output token sequence to obtain a predicted preference pattern.

9. The system according to claim 8, wherein the circuitry is configured to update the selection parameters based on the predicted preference pattern by extracting predicted attribute preferences from the decoded output, adjusting attribute weight parameters in the scoring function, and re-tokenizing the prompt sentence with the updated selection parameters.

10. The system according to claim 1, wherein the circuitry is configured to receive evaluation information from the terminal device indicating whether records in the ranked result set were accepted or modified by the user, incorporate the evaluation information into a feedback loop, and update a preference model stored in the storage device based on the evaluation information.

11. The system according to claim 10, wherein the circuitry is configured to feed updated parameters from the preference model back into the prompt sentence generation and inference parameters to pre-filter ranked result sets in subsequent sessions.

12. The system according to claim 1, wherein the circuitry is configured to generate an optimization prompt sentence incorporating a query response time metric and a query execution plan from the storage device, transmit the optimization prompt sentence to the inference engine, decode an output token sequence to obtain a revised query expression, validate the revised query expression against a grammar schema stored in the storage device, and apply the validated revised query expression to subsequent data retrieval operations.

13. The system according to claim 12, wherein the circuitry is configured to monitor a throughput metric of the communication interface, and when the throughput metric falls below a target value, reduce the prompt sentence length by truncating the context section to a reduced maximum token count to decrease inference engine processing time.

14. The system according to claim 1, wherein the circuitry is configured to store the tokenized prompt sentence, the ranked result set text string, and the parsed record identifiers as a session record in the storage device indexed by a session identifier, and retrieve prior session records to compute a result acceptance rate indicating the fraction of prior results incorporated into user selections.

15. The system according to claim 14, wherein the circuitry is configured to compute a session relevance score between a current selection parameter vector and prior session parameter vectors in the storage device, retrieve top-m prior session records by descending session relevance score, and include the retrieved prior session records as history context in the prompt sentence.

16. The system according to claim 1, wherein the circuitry is configured to periodically acquire updated attribute data from an external data service via the communication interface, apply a differential update procedure to identify newly added, modified, or removed attribute records relative to stored records in the storage device, update the storage device accordingly, and invalidate cached scoring results for modified records.

17. The system according to claim 16, wherein the circuitry is configured to recompute aggregate scores and preference match scores for updated attribute records, update the canonical identifiers stored in the storage device, and generate an update notification prompt sentence incorporating a summary of attribute changes for transmission to the inference engine.

18. A system comprising:
circuitry configured to:
receive, via a communication interface coupled to a packet-switched network, selection parameters and interaction history data from a terminal device, and generate a structured condition incorporating the selection parameters stored in a storage device;
tokenize a prompt sentence incorporating the structured condition and interaction history data, transmit the tokenized prompt sentence to an inference engine executing a generative neural network model, and decode an output token sequence to obtain a ranked result set as a text string;
parse the text string to extract record identifiers, attribute descriptions, and relevance scores, compute a multi-attribute weighted aggregate score and a cosine similarity preference match score for each record, and filter records below a combined score threshold; and
transmit the filtered ranked result set to the terminal device via the communication interface, and update a preference model stored in the storage device based on evaluation information received from the terminal device.

19. The system according to claim 18, wherein the circuitry is configured to generate an optimization prompt sentence incorporating a query response time metric, transmit the optimization prompt sentence to the inference engine, decode a revised query expression, validate the revised query expression against a grammar schema, and apply the validated expression to subsequent data retrieval operations.

20. A method comprising:
receiving, via a communication interface coupled to a packet-switched network, selection parameters and interaction history data from a terminal device, and generating a structured condition incorporating the selection parameters stored in a storage device;
tokenizing a prompt sentence incorporating the structured condition and interaction history data, configuring inference parameters including temperature and maximum output length, transmitting the tokenized prompt sentence to an inference engine executing a generative neural network model, and decoding an output token sequence from the inference engine to obtain a ranked result set as a text string; and
parsing the text string to extract record identifiers, attribute descriptions, and relevance scores, normalizing the extracted record identifiers to canonical identifiers stored in the storage device, and transmitting the parsed ranked result set to the terminal device via the communication interface.
